(19) United States
(12) Patent Application Publication
(10) Pub. No.: US 2023/0046614 A1
(43) Pub. Date: Feb. 16, 2023

(54) OBSERVATION APPARATUS, OBSERVATION METHOD, AND DISTANCE MEASUREMENT SYSTEM

(71) Applicant: SONY SEMICONDUCTOR SOLUTIONS CORPORATION, KANAGAWA (JP)

(72) Inventor: YASUNORI TSUKUDA, KANAGAWA (JP)

(21) Appl. No.: 17/758,293

(22) PCT Filed: Dec. 28, 2020
(86) PCT No.: PCT/JP2020/049111

§ 371 Date: Jun. 30, 2022

(30) Foreign Application Priority Data
Jan. 15, 2020 (JP) 2020-004315

(51) Int. Cl. G01C 3/06; G01S 7/4861

(52) U.S. Cl. CPC G01C 3/06; G01S 7/4861

(57) ABSTRACT

The present technology relates to an observation apparatus, an observation method, and a distance measurement system capable of improving distance measurement accuracy. A first measurement unit that measures a first number of reactions of a light receiving element in response to incidence of photons on a first pixel, a second measurement unit that measures a second number of reactions of the light receiving element in response to incidence of photons on a second pixel, a light emitting unit that emits light to the second pixel, and a light emission control unit that controls the light emitting unit according to a difference between the first number of reactions and the second number of reactions are included. The present technology can be applied to, for example, a distance measurement apparatus that measures a distance to a predetermined object, and can be applied to an observation apparatus that observes a characteristic of a pixel included in the distance measurement apparatus.

### TECHNICAL FIELD

The present technology relates to an observation apparatus, an observation method, and a distance measurement system, and for example, relates to an observation apparatus, an observation method, and a distance measurement system capable of observing a characteristic of a pixel related to distance measurement and measuring a distance more accurately.

### BACKGROUND ART

In recent years, a distance measurement sensor that measures a distance by a time-of-flight (ToF) method has attracted attention. Examples of such a distance measurement sensor include a distance measurement sensor using a single photon avalanche diode (SPAD) as a pixel. In the SPAD, avalanche amplification occurs when one photon enters a P-N junction region of a high electric field in a state where a voltage higher than a breakdown voltage is applied. By detecting a timing at which a current instantaneously flows at that time, distance measurement can be performed with high accuracy.

For example, Patent Document 1 describes that, in a distance measurement sensor using an SPAD, a part of distance measurement light is separated and received, a reference light amount is compared with a received light amount, and a difference therebetween is fed back to a light source control unit, thereby controlling a light source.

### CITATION LIST

### Patent Document

Patent Document 1: Japanese Patent Application Laid-Open No. 2019-27783

### SUMMARY OF THE INVENTION

### Problems to be Solved by the Invention

There is a possibility that a difference occurs between a characteristic of a pixel for distance measurement and a characteristic of a pixel for acquiring a reference light amount due to a difference in environment, a difference in usage condition, and the like between the pixel for distance measurement and the pixel for acquiring the reference light amount. There has been a possibility that distance measurement accuracy deteriorates in a case where a difference occurs between the characteristic of the pixel for distance measurement and the characteristic of the pixel for acquiring the reference light amount.

The present technology has been made in view of such a situation, and an object of the present technology is to prevent a difference from occurring between a characteristic of a pixel for distance measurement and a characteristic of a pixel for acquiring a reference light amount, and to improve distance measurement accuracy.

### Solutions to Problems

An observation apparatus according to one aspect of the present technology includes: a first measurement unit that measures a first number of reactions of a light receiving element in response to incidence of photons on a first pixel; a second measurement unit that measures a second number of reactions of the light receiving element in response to incidence of photons on a second pixel; a light emitting unit that emits light to the second pixel; and a light emission control unit that controls the light emitting unit according to a difference between the first number of reactions and the second number of reactions.

An observation method according to one aspect of the present technology includes: by an observation apparatus, measuring a first number of reactions of a light receiving element in response to incidence of photons on a first pixel; measuring a second number of reactions of the light receiving element in response to incidence of photons on a second pixel; and controlling a light emitting unit that emits light to the second pixel according to a difference between the first number of reactions and the second number of reactions.

A distance measurement system according to one aspect of the present technology includes: a distance measurement apparatus that includes a first light emitting unit that emits irradiation light and a first pixel that receives reflected light obtained by reflecting the light from the first light emitting unit to an object, and measures a distance to the object; and an observation apparatus that includes a first measurement unit that measures a first number of reactions of a light receiving element in response to incidence of photons on the first pixel, a second measurement unit that measures a second number of reactions of the light receiving element in response to incidence of photons on a second pixel, a second light emitting unit that emits light to the second pixel, and a light emission control unit that controls the second light emitting unit according to a difference between the first number of reactions and the second number of reactions, and observes a characteristic of the first pixel.

In the observation apparatus and the observation method according to one aspect of the present technology, the first number of reactions of the light receiving element in response to incidence of photons on the first pixel is measured, the second number of reactions of the light receiving element in response to incidence of photons on the second pixel is measured; and the light emitting unit that emits light to the second pixel is controlled according to the difference between the first number of reactions and the second number of reactions.

The distance measurement system according to one aspect of the present technology includes the distance measurement apparatus that includes the first light emitting unit that emits the irradiation light and the first pixel that receives the reflected light obtained by reflecting the light from the first light emitting unit to the object, and measures the distance to the object. Furthermore, the distance measurement system includes the observation apparatus that includes the first measurement unit that measures the first number of reactions of the light receiving element in response to incidence of photons on the first pixel, the second measurement unit that measures the second number of reactions of the light receiving element in response to incidence of photons on the second pixel, the second light emitting unit that emits light to the second pixel, and the light emission control unit that controls the second light emitting unit according to the difference between the first number of reactions and the second number of reactions, and measures the characteristic of the first pixel.

Note that the distance measurement apparatus may be an independent apparatus or an internal block included in one apparatus.

Furthermore, a program can be provided by being transmitted via a transmission medium or by being recorded on a recording medium.

### BRIEF DESCRIPTION OF DRAWINGS

FIG. 1 is a diagram depicting a configuration of an embodiment of a distance measurement apparatus to which the present technology is applied.

FIG. 2 is a diagram depicting an example of a configuration of a light receiving apparatus.

FIG. 3 is a diagram depicting an example of a configuration of an observation apparatus.

FIG. 4 is a diagram depicting another example of the configuration of the observation apparatus.

FIG. 5 is a diagram for explaining an example of arrangement of a distance measurement pixel and an observation pixel.

FIG. 6 is a circuit diagram of the pixel.

FIG. 7 is a diagram for explaining an operation of the pixel.

FIG. 8 is a diagram depicting an example of a cross-sectional configuration of the distance measurement pixel.

FIG. 9 is a diagram depicting an example of a cross-sectional configuration of the observation pixel.

FIG. 10 is a flowchart for explaining first processing of a characteristic control.

FIG. 11 is a flowchart for explaining distance measurement processing.

FIG. 12 is a flowchart for explaining characteristic acquisition processing.

FIG. 13 is a flowchart for explaining optimum light amount control processing.

FIG. 14 is a diagram for explaining generation of a histogram.

FIG. 15 is a flowchart for explaining second processing of the characteristic control.

FIG. 16 is a view depicting an example of a schematic configuration of an endoscopic surgery system.

FIG. 17 is a block diagram depicting an example of a functional configuration of a camera head and a camera control unit (CCU).

FIG. 18 is a block diagram depicting an example of schematic configuration of a vehicle control system.

FIG. 19 is a diagram of assistance in explaining an example of installation positions of an outside-vehicle information detecting section and an image pickup section.

### MODE FOR CARRYING OUT THE INVENTION

Hereinafter, modes for implementing the present technology (hereinafter, referred to as embodiments) will be described.

<Example of Configuration of Distance Measurement System>

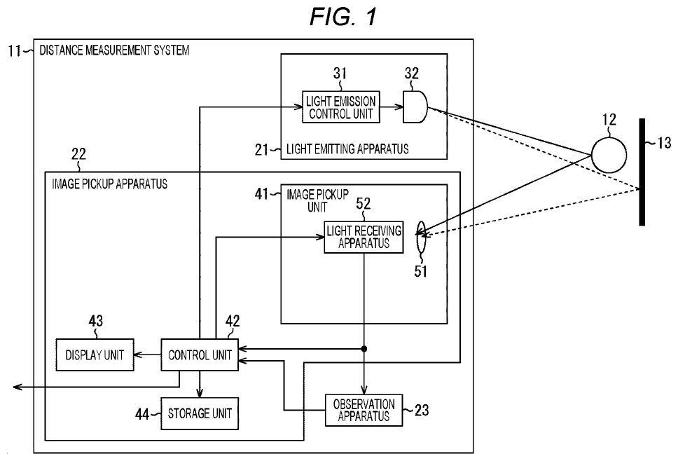

FIG. 1 is a block diagram depicting an example of a configuration of an embodiment of a distance measurement system to which the present technology is applied.

A distance measurement system 11 is, for example, a system that captures a distance image using a time-of-flight (ToF) method. Here, the distance image is an image in which a distance in a depth direction from the distance measurement system 11 to a subject (object) is detected in units of pixels, and a signal of each pixel includes a distance pixel signal based on the detected distance.

The distance measurement system 11 includes a light emitting apparatus 21, an image pickup apparatus 22, and an observation apparatus 23.

The light emitting apparatus 21 includes a light emission control unit 31 and a light emitting unit 32.

The light emission control unit 31 controls a pattern in which the light emitting unit 32 emits light under the control of a control unit 42 of the image pickup apparatus 22. Specifically, the light emission control unit 31 controls the pattern in which the light emitting unit 32 emits the light according to an irradiation code included in an irradiation signal supplied from the control unit 42. For example, the irradiation code includes a binary value of 1 (high) or 0 (low), and the light emission control unit 31 turns on the light emitting unit 32 in a case where the value of the irradiation code is 1, and turns off the light emitting unit 32 in a case where the value of the irradiation code is 0.

The light emitting unit 32 emits light in a predetermined wavelength region under the control of the light emission control unit 31. The light emitting unit 32 includes, for example, an infrared laser diode. Note that the type of the light emitting unit 32 and the wavelength range of the irradiation light can be arbitrarily set according to the application of the distance measurement system 11 and the like.

The image pickup apparatus 22 is an apparatus that receives reflected light obtained by reflecting the light (irradiation light) emitted from the light emitting apparatus 21 to a subject 12, a subject 13, and the like. The image pickup apparatus 22 includes an image pickup unit 41, the control unit 42, a display unit 43, and a storage unit 44.

The image pickup unit 41 includes a lens 51 and a light receiving apparatus 52.

The lens 51 forms an image of incident light on a light receiving surface of the light receiving apparatus 52. Note that the lens 51 has an arbitrary configuration, and for example, the lens 51 can be implemented by a plurality of lens groups.

The light receiving apparatus 52 includes, for example, a sensor using a single photon avalanche diode (SPAD) for each pixel. Under the control of the control unit 42, the light receiving apparatus 52 receives the reflected light from the subject 12, the subject 13, and the like, converts a pixel signal obtained as a result thereof into distance information, and outputs the distance information to the control unit 42. The light receiving apparatus 52 supplies, to the control unit 42, a distance image storing a digital count value obtained by counting a time from when the light emitting apparatus 21 emits the irradiation light to when the light receiving apparatus 52 receives the light, as a pixel value (distance pixel signal) of each pixel of a pixel array in which pixels are two-dimensionally arranged in a matrix form in a row direction and a column direction. A light emission timing signal indicating a timing at which the light emitting unit 32 emits light is also supplied from the control unit 42 to the light receiving apparatus 52.

Note that the distance measurement system 11 repeats light emission of the light emitting unit 32 and reception of the reflected light a plurality of times (for example, several thousands to several tens of thousands of times), so that the image pickup unit 41 generates a distance image from which an influence of disturbance light, multipath, or the like is removed, and supplies the distance image to the control unit 42.

The control unit 42 is implemented by, for example, a control circuit such as a field programmable gate array (FPGA) or a digital signal processor (DSP), a processor, or the like. The control unit 42 controls the light emission control unit 31 and the light receiving apparatus 52. Specifically, the control unit 42 supplies the irradiation signal to the light emission control unit 31 and supplies the light emission timing signal to the light receiving apparatus 52. The light emitting unit 32 emits the irradiation light according to the irradiation signal. The light emission timing signal may be an irradiation signal supplied to the light emission control unit 31. Furthermore, the control unit 42 supplies the distance image acquired from the image pickup unit 41 to the display unit 43 and causes the display unit 43 to display the distance image. Moreover, the control unit 42 stores the distance image acquired from the image pickup unit 41 in the storage unit 44. Furthermore, the control unit 42 outputs the distance image acquired from the image pickup unit 41 to the outside.

The display unit 43 includes, for example, a panel type display apparatus such as a liquid crystal display apparatus or an organic electro luminescence (EL) display apparatus.

The storage unit 44 can be implemented by an arbitrary storage apparatus, a storage medium, or the like, and stores the distance image or the like.

Processing related to distance measurement is performed in each of these units. In order to further improve distance measurement accuracy, the distance measurement system 11 includes the observation apparatus 23. The observation apparatus 23 observes a characteristic of the pixel included in the light receiving apparatus 52. The observation apparatus 23 receives a signal from the light receiving apparatus 52. In addition, the observation apparatus 23 supplies an observation result to the control unit 42. The control unit 42 controls a voltage value of a bias voltage to be supplied to each pixel of the light receiving apparatus 52 by using, for example, the observation result from the observation apparatus 23.

<Example of Configuration of Light Receiving Apparatus>

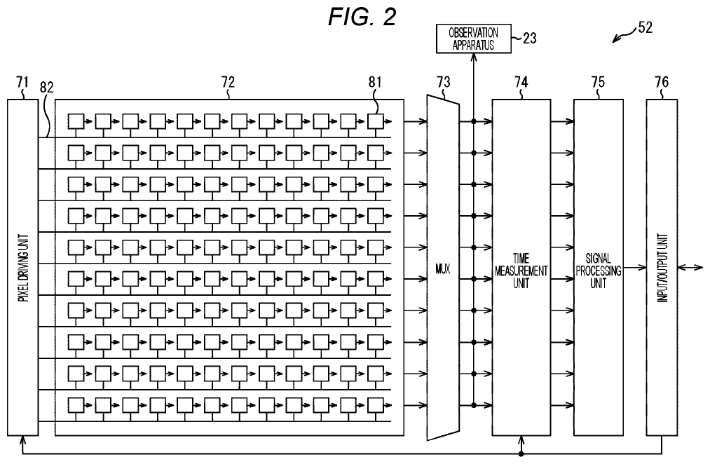

FIG. 2 is a block diagram depicting an example of a configuration of the light receiving apparatus 52.

The light receiving apparatus 52 includes a pixel driving unit 71, a pixel array 72, a multiplexer (MUX) 73, a time measurement unit 74, a signal processing unit 75, and an input/output unit 76.

The pixel array 72 has a configuration in which pixels 81 that detect incidence of photons and output a detection signal indicating a detection result as a pixel signal are two-dimensionally arranged in a matrix form in a row direction and a column direction. Here, the row direction refers to a direction in which the pixels 81 are arranged in a horizontal direction, and the column direction refers to a direction in which the pixels 81 are arranged in a vertical direction. FIG. 2 depicts a case where the pixel array 72 has a configuration in which pixels of 10 rows and 12 columns are arranged due to paper restriction, but the number of rows and the number of columns of the pixel array 72 are not limited thereto and are arbitrary.

A pixel drive line 82 is wired in the horizontal direction for each pixel row for the matrix-like pixel arrangement of the pixel array 72. Note that, although the description will be continued here assuming that the pixel drive line 82 is wired for each pixel row, the pixel drive line 82 may be wired for each pixel column or may be wired for each of the pixel row and the pixel column. The pixel drive line 82 transmits a drive signal for driving the pixel 81. The pixel driving unit 71 drives each pixel 81 by supplying a predetermined drive signal to each pixel 81 via the pixel drive line 82. Specifically, the pixel driving unit 71 performs a control such that at least some of the plurality of pixels 81 two-dimensionally arranged in a matrix form are set as active pixels and the remaining pixels 81 are set as inactive pixels at a predetermined timing corresponding to the light emission timing signal supplied from the outside via the input/output unit 76.

The active pixel is a pixel that detects incidence of photons, and the inactive pixel is a pixel that does not detect incidence of photons. It is a matter of course that all the pixels 81 of the pixel array 72 may be the active pixels. A detailed configuration of the pixel 81 will be described later.

Note that, although FIG. 2 depicts a case where the pixel drive line 82 is one wiring, the pixel drive line 82 may be a plurality of wirings. One end of the pixel drive line 82 is connected to an output terminal corresponding to each pixel row of the pixel driving unit 71.

The MUX 73 selects an output from the active pixel according to switching between the active pixel and the inactive pixel in the pixel array 72. Then, the MUX 73 outputs the pixel signal input from the selected active pixel to the time measurement unit 74. The pixel signal from the MUX 73 is also supplied to the observation apparatus 23.

On the basis of the pixel signal of the active pixel supplied from the MUX 73 and the light emission timing signal indicating the light emission timing of the light emitting unit 32, the time measurement unit 74 generates a count value corresponding to a time from when the light emitting unit 32 emits light to when the active pixel receives the light. The time measurement unit 74 is also called a time-to-digital converter (TDC). The light emission timing signal is supplied from the outside (the control unit 42 of the image pickup apparatus 22) via the input/output unit 76.

The signal processing unit 75 creates, on the basis of the light emission of the light emitting unit 32 repeatedly performed a predetermined number of times (for example, several thousands to several tens of thousands of times) and the reception of the reflected light, a histogram of a time (count value) until the reflected light is received for each pixel. Then, by detecting a peak of the histogram, the signal processing unit 75 determines a time until the light emitted from the light emitting unit 32 is reflected from the subject 12 or the subject 13 and returns. The signal processing unit 75 generates a distance image in which a digital count value obtained by counting a time until the light receiving apparatus 52 receives light is stored in each pixel, and supplies the distance image to the input/output unit 76. Alternatively, the signal processing unit 75 may perform calculation to obtain the distance to the object on the basis of the determined time and light speed, generate a distance image in which the calculation result is stored in each pixel, and supply the distance image to the input/output unit 76.

The input/output unit 76 outputs a signal of the distance image (distance image signal) supplied from the signal processing unit 75 to the outside (the control unit 42). Furthermore, the input/output unit 76 acquires the light emission timing signal supplied from the control unit 42 and supplies the light emission timing signal to the pixel driving unit 71 and the time measurement unit 74.

<Example of Configuration of Observation Apparatus>

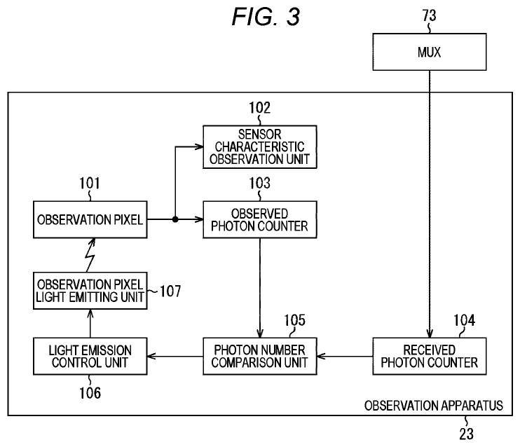

FIG. 3 depicts an example of a configuration of the observation apparatus 23.

The observation apparatus 23 includes an observation pixel 101, a sensor characteristic observation unit 102, an observed photon counter 103, a received photon counter 104, a photon number comparison unit 105, a light emission control unit 106, and an observation pixel light emitting unit 107.

The observation pixel 101 is a pixel having a configuration equivalent to that of the pixel 81 arranged in the pixel array 72 of the light receiving apparatus 52. For example, in a case where the pixel 81 (hereinafter, referred to as the distance measurement pixel 81 as needed) arranged in the pixel array 72 is a sensor using an SPAD, the observation pixel 101 is also a sensor using an SPAD. Here, a case where both the distance measurement pixel 81 and the observation pixel 101 are sensors each using an SPAD will be described as an example.

The observation pixel 101 is configured not to receive light from the outside. The observation pixel 101 is configured to receive light from the observation pixel light emitting unit 107 as described later and not to receive light from other than the observation pixel light emitting unit 107.

The sensor characteristic observation unit 102 observes a characteristic of the observation pixel 101. The characteristic of the observation pixel 101 is treated as a characteristic of the distance measurement pixel 81. Therefore, in a case where a difference occurs between the characteristic of the observation pixel 101 and the characteristic of the distance measurement pixel 81, there is a possibility that an error occurs in the control of the distance measurement pixel 81, and thus, it is desirable to observe the characteristic of the observation pixel 101 with high accuracy. In the present embodiment, as described below, processing is performed such that no difference occurs between the characteristic of the observation pixel 101 and the characteristic of the distance measurement pixel 81.

Examples of the characteristic of the sensor include photon detection efficiency (PDE) representing a probability of detection of one incident photon, a dark count rate (DCR) representing a frequency of occurrence of avalanche amplification due to a dark current, a breakdown voltage (Vbd), and a reaction delay time of an SPAD. The sensor characteristic observation unit 102 may observe any one of these characteristics or may observe a plurality of characteristics. In addition, a configuration in which characteristics that are not depicted here are observed is also possible.

As described above, since the observation pixel 101 is in a state of being shielded from light, electrons are not generated by photoelectric conversion made as light is received. However, there is a possibility that photons are generated due to an influence of a dark current or the like. The observation pixel 101 is provided in order to observe the characteristic of the pixel such as the frequency of occurrence of avalanche amplification due to the dark current (DCR) and the PDE.

As such, the characteristic of the pixel obtained by the observation pixel 101 is also treated as the characteristic of the distance measurement pixel 81. For example, it is assumed that the influence of the dark current observed by the observation pixel 101 is similarly applied to the distance measurement pixel 81, and the bias voltage applied to the distance measurement pixel 81 is controlled or a light emission intensity of the light emitting unit 32 is controlled.

However, since the distance measurement pixel 81 receives reflected light of the light emitted by the light emitting unit 32 (FIG. 1) and receives background light, it is in a situation different from that of the observation pixel 101. Therefore, a change in characteristic of the distance measurement pixel 81 and a change in characteristic of the observation pixel 101 are not necessarily the same. The distance measurement pixel 81 may change in characteristic by receiving light, in other words, the distance measurement pixel 81 may deteriorate, but since the observation pixel 101 does not receive light, it is assumed that at least deterioration equivalent to that of the distance measurement pixel 81 does not occur.

Note that, although the term “deterioration” is used herein, the term “deterioration” indicates a change in characteristic and does not necessarily mean deterioration from a previous state. In addition, even if deterioration occurs, the original state (the characteristic before the change) may return depending on the subsequent state. Therefore, temporary deterioration is also included.

Even if a change in characteristic is observed by the observation pixel 101, in a case where the observed change (deterioration) in characteristic deviates from the change in characteristic of the distance measurement pixel 81, there is a possibility that accuracy of a control using the characteristic observed by the observation pixel 101 is degraded. The present embodiment has a mechanism for deteriorating the observation pixel 101 in accordance with deterioration of the distance measurement pixel 81. In other words, the observation pixel 101 is also caused to change according to the change in characteristic of the distance measurement pixel 81, so that a state in which the change in characteristic of the pixel observed by the observation pixel 101 and the change in characteristic of the distance measurement pixel 81 match is maintained.

In order to maintain the state in which the change in characteristic of the pixel observed by the observation pixel 101 and the change in characteristic of the distance measurement pixel 81 match, the number of reactions of photons of the observation pixel 101 and the number of reactions of photons of the distance measurement pixel 81 are compared, whether or not the characteristics match are determined, and processing for performing a control to make the characteristic match in a case where the characteristics do not match is performed.

The observation apparatus 23 depicted in FIG. 3 includes the observed photon counter 103 that counts the number of reactions of photons of the observation pixel 101 and the received photon counter 104 that counts the number of reactions of photons of the distance measurement pixel 81.

The observed photon counter 103 counts the number of photons reacted in the observation pixel 101 (the number of reactions). Similarly, the received photon counter 104 counts the number of photons reacted in the distance measurement pixel 81 (the number of reactions). The number of photons counted by the observed photon counter 103 (referred to as the number of observed photons) and the number of photons counted by the received photon counter 104 (referred to as the number of received photons) are supplied to the photon number comparison unit 105.

The photon number comparison unit 105 compares the number of observed photons with the number of received photons, generates a parameter for controlling the light emission of the observation pixel light emitting unit 107 on the basis of the comparison result, and supplies the parameter to the light emission control unit 106. The light emission control unit 106 controls the light emission of the observation pixel light emitting unit 107 on the basis of the supplied parameter.

The observation pixel 101 is irradiated with light in such a manner that the numbers of photons match, in other words, the characteristics match, and processing for causing deterioration to the same extent as that of deterioration of the distance measurement pixel 81 is performed. A detailed description thereof will be provided later.

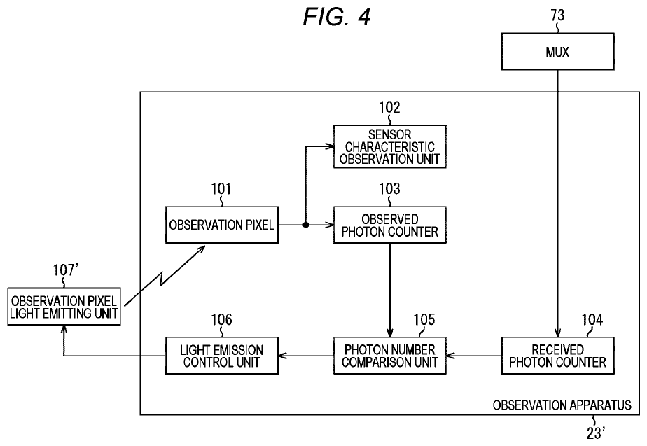

The observation pixel light emitting unit 107 is a light emitting source that emits light to the observation pixel 101. Furthermore, light emitted by the observation pixel light emitting unit 107 is not received by the distance measurement pixel 81. The observation pixel light emitting unit 107 may be included in the observation apparatus 23 as depicted in FIG. 3. The observation pixel light emitting unit 107 may also be provided outside the observation apparatus 23 as depicted in FIG. 4.

An observation apparatus 23′ depicted in FIG. 4 includes an observation pixel light emitting unit 107′ outside the observation apparatus 23′. It is sufficient if the observation pixel light emitting unit 107 and the observation pixel light emitting unit 107′ are configured to emit light only to the observation pixel 101 and provided at a position that does not affect the distance measurement pixel 81 and the like.

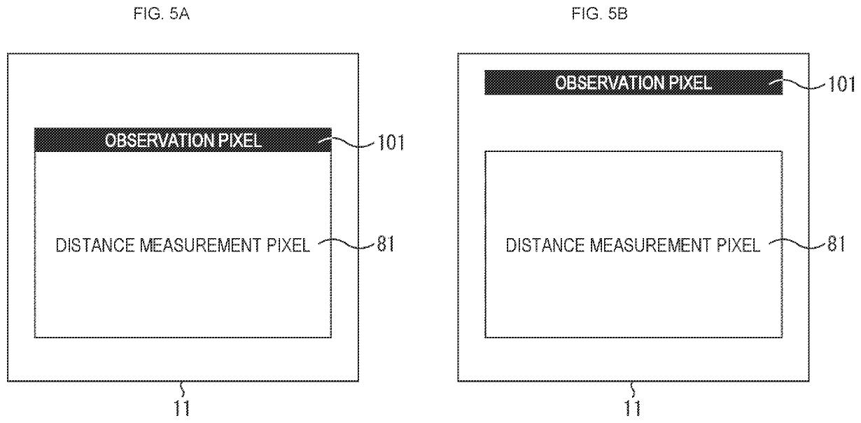

For example, in a case where the distance measurement pixel 81 and the observation pixel 101 are provided adjacent to each other as depicted in A of FIG. 5, as in the observation apparatus 23 depicted in FIG. 3, a configuration in which the observation pixel light emitting unit 107 is provided in the observation apparatus 23 may be applied. In this case, as the observation pixel light emitting unit 107 is provided in the observation apparatus 23, light can be emitted to the observation pixel 101 without affecting the adjacent distance measurement pixel 81.

Furthermore, for example, in a case where the distance measurement pixel 81 and the observation pixel 101 are provided at positions away from each other as depicted in B of FIG. 5, a configuration in which the observation pixel light emitting unit 107′ is provided outside the observation apparatus 23′ as in the observation apparatus 23′ depicted in FIG. 4 may be applied. In this case, if the observation pixel light emitting unit 107′ is arranged at a position at which irradiation of the distance measurement pixel 81 with light from the observation pixel light emitting unit 107′ provided outside the observation apparatus 23′ is not possible, light can be emitted to the observation pixel 101 without affecting the distance measurement pixel 81.

Furthermore, even in a case where the distance measurement pixel 81 and the observation pixel 101 are arranged at positions away from each other as depicted in B of FIG. 5, the observation apparatus 23 depicted in FIG. 3 may be applied, and the observation pixel light emitting unit 107 may be provided inside.

The distance measurement pixel 81 is configured to receive light emitted from the light emitting unit 32 (FIG. 1), but the observation pixel 101 is shielded from light and is configured not to receive the light from the light emitting unit 32 or background light. The observation pixel 101 is shielded from light so as not to be affected by an external environment in order to observe the characteristic of the pixel.

Whether the observation pixel light emitting unit 107 is provided inside the observation apparatus 23 or outside the observation apparatus 23 may be designed according to the arrangement of the distance measurement pixel 81 and the observation pixel 101.

In a case where the distance measurement pixel 81 and the observation pixel 101 are arranged at positions close to each other as depicted in A of FIG. 5, a predetermined number of pixels 81 in the distance measurement pixel 81 may be provided as the observation pixels 101. In other words, some of the pixels 81 of the pixel array 72 (FIG. 2) may be used as the observation pixels 101. In this case, there may be a time during which one pixel functions as the observation pixel 101 and a time during which one pixel functions as the distance measurement pixel 81.

The observation pixel 101 may be one pixel. Furthermore, the observation pixel 101 may include an M×N (M≥1 and N≥1) pixel array.

In a case where the observation pixel 101 is configured as a pixel array including M×N pixels (SPAD), the observation apparatus 23 may have a configuration in which a substrate of the pixel array of the observation pixel 101 and a substrate on which functions other than the observation pixel 101, for example, functions (logic circuits) such as the observed photon counter 103 and the received photon counter 104 are mounted are stacked.

(Example of Configuration of Pixel Circuit)

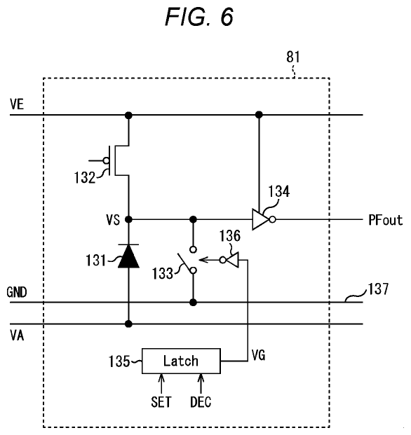

FIG. 6 illustrates an example of a circuit configuration of the pixels 81 plurally arranged in a matrix form in the pixel array 72. Since the distance measurement pixel 81 and the observation pixel 101 have the same configuration, an example of the configuration of the distance measurement pixel 81 and an example of the configuration of the observation pixel 101 will be described together as the pixel 81.

The pixel 81 in FIG. 3 includes an SPAD 131, a transistor 132, a switch 133, and an inverter 134. Furthermore, the pixel 81 also includes a latch circuit 135 and an inverter 136. The transistor 132 is implemented by a P-type MOS transistor.

A cathode of the SPAD 131 is connected to a drain of the transistor 132 and is connected to an input terminal of the inverter 134 and one end of the switch 133. An anode of the SPAD 131 is connected to a power supply voltage VA (hereinafter, also referred to as an anode voltage VA).

The SPAD 131 is a photodiode (single photon avalanche photodiode) that performs avalanche amplification of generated electrons and outputs a signal of a cathode voltage VS once light is incident. The power supply voltage VA supplied to the anode of the SPAD 131 is, for example, a negative bias (negative potential) of about −20 V.

The transistor 132 is a constant current source that operates in a saturation region, and performs passive quenching by serving as a quenching resistor. A source of the transistor 132 is connected to a power supply voltage VE, and the drain is connected to the cathode of the SPAD 131, the input terminal of the inverter 134, and one end of the switch 133. As a result, the power supply voltage VE is also supplied to the cathode of the SPAD 131. A pull-up resistor can also be used instead of the transistor 132 connected in series to the SPAD 131.

In order to detect light (photons) with sufficient efficiency, a voltage higher than the breakdown voltage VBD of the SPAD 131 (hereinafter, referred to as excess bias) is applied to the SPAD 131. For example, in a case where the breakdown voltage VBD of the SPAD 131 is 20 V and a voltage higher than the breakdown voltage VBD by 3 V is applied, the power supply voltage VE supplied to the source of the transistor 132 is 3 V.

Note that the breakdown voltage VBD of the SPAD 131 greatly changes depending on a temperature or the like. Therefore, an applied voltage (excess bias) to be applied to the SPAD 131 is controlled (adjusted) according to the change in breakdown voltage VBD. For example, in a case where the power supply voltage VE is a fixed voltage, the anode voltage VA is controlled (adjusted).

One end of the switch 133 is connected to the cathode of the SPAD 131, the input terminal of the inverter 134, and the drain of the transistor 132, and the other end of the switch 133 is connected to a ground connection line 137 connected to a ground (GND). The switch 133 can be implemented by, for example, an N-type MOS transistor, and turns on and off a gating control signal VG, which is an output of the latch circuit 135, according to an inverted gating signal VG_I obtained by inversion performed by the inverter 136.

The latch circuit 135 supplies, to the inverter 136, the gating control signal VG for controlling the pixel 81 to be the active pixel or the inactive pixel on the basis of a trigger signal SET supplied from the pixel driving unit 71 and address data DEC. The inverter 136 generates the inverted gating signal VG_I obtained by inverting the gating control signal VG and supplies the inverted gating signal VG_I to the switch 133.

The trigger signal SET is a timing signal indicating a timing at which the gating control signal VG is switched, and the address data DEC is data indicating an address of a pixel to be set as the active pixel among the plurality of pixels 81 arranged in a matrix from in the pixel array 72. The trigger signal SET and the address data DEC are supplied from the pixel driving unit 71 via the pixel drive line 82.

The latch circuit 135 reads the address data DEC at a predetermined timing indicated by the trigger signal SET. Then, in a case where a pixel address (of the pixel 81) corresponding to the latch circuit 135 is included in the pixel address indicated by the address data DEC, the latch circuit 135 outputs the gating control signal VG of Hi (1) for setting the pixel 81 corresponding to itself as the active pixel. On the other hand, in a case where the pixel address (of the pixel 81) corresponding to itself is not included in the pixel address indicated by the address data DEC, the latch circuit 135 outputs the gating control signal VG of Lo (0) for setting the pixel 81 corresponding to itself as the inactive pixel.

Accordingly, in a case where the pixel 81 is set as the active pixel, the inverted gating signal VG_I of Lo (0) obtained by inversion performed by the inverter 136 is supplied to the switch 133. On the other hand, in a case where the pixel 81 is set as the inactive pixel, the inverted gating signal VG_I of Hi (1) is supplied to the switch 133. Therefore, the switch 133 is turned off (disconnected) in a case where the pixel 81 is set as the active pixel, and the switch 133 is turned on (connected) in a case where the pixel 81 is set as the inactive pixel.

The inverter 134 outputs a detection signal PFout of Hi in a case where the cathode voltage VS as an input signal is Lo, and the inverter 134 outputs the detection signal PFout of Lo in a case where the cathode voltage VS is Hi. The inverter 134 is an output unit that outputs, as the detection signal PFout, incidence of photons on the SPAD 131.

Although the configuration of the pixel 81 depicted in FIG. 6 has been described as being the same between the distance measurement pixel 81 and the observation pixel 101, it is a matter of course that the observation pixel 101 can have only a configuration necessary for the observation pixel 101 instead of the configuration depicted in FIG. 6.

For example, in a case where only one observation pixel 101 is provided or in a case where a plurality of observation pixels 101 is provided but is always set as the active pixels, a configuration in which a function corresponding to each of the latch circuit 135 and the switch 133 and the inverter 136 attached to the latch circuit 135 is omitted is also possible. The configuration of the observation pixel 101 can be changed as appropriate.

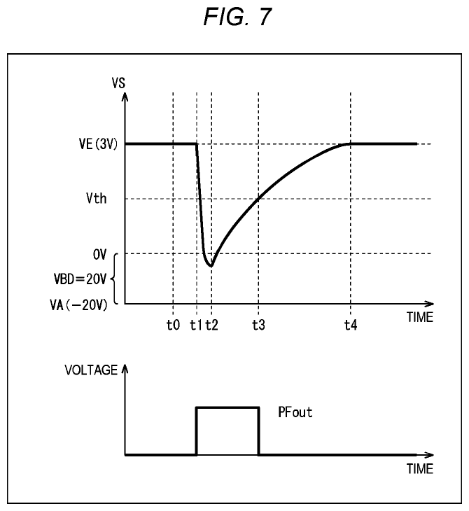

Next, an operation in a case where the pixel 81 is set as the active pixel will be described with reference to FIG. 7. FIG. 7 is a graph depicting a change in cathode voltage VS of the SPAD 131 in response to incidence of photons and the detection signal PFout.

First, in a case where the pixel 81 is the active pixel, the switch 133 is set to OFF as described above. Since the power supply voltage VE (for example, 3 V) is supplied to the cathode of the SPAD 131 and the power supply voltage VA (for example, −20 V) is supplied to the anode thereof, a reverse voltage higher than the breakdown voltage VBD (=20 V) is applied to the SPAD 131, so that the SPAD 131 is set to a Geiger mode. In this state, the cathode voltage VS of the SPAD 131 is the same as the power supply voltage VE, for example, as at time t0 in FIG. 7.

Once photons are incident on the SPAD 131 set to the Geiger mode, avalanche multiplication occurs, and a current flows through the SPAD 131.

Assuming that avalanche multiplication occurs and a current flows through the SPAD 131 at time t1 in FIG. 7, the current also flows through the transistor 132 as the current flows through the SPAD 131 after time t1, so that a voltage drop occurs due to a resistance component of the transistor 132.

In a case where the cathode voltage VS of the SPAD 131 falls below 0 V at time t2, an anode-cathode voltage of the SPAD 131 becomes lower than the breakdown voltage VBD, so that the avalanche amplification is stopped. Here, as the current generated by the avalanche amplification flows through the transistor 132, a voltage drop occurs, and the cathode voltage VS becomes lower than the breakdown voltage VBD along with the voltage drop occurred, whereby an operation of stopping the avalanche amplification is a quenching operation.

Once the avalanche amplification is stopped, the current flowing through a resistor of the transistor 132 gradually decreases, and at time t4, the cathode voltage VS returns to the original power supply voltage VE again, so that a next new photon can be detected (recharge operation).

The inverter 134 outputs the detection signal PFout of Lo in a case where the cathode voltage VS as an input voltage is equal to or higher than a predetermined threshold voltage Vth, and the inverter 134 outputs the detection signal PFout of Hi in a case where the cathode voltage VS is lower than the predetermined threshold voltage Vth. Therefore, in a case where, as photons are incident on the SPAD 131, the avalanche multiplication occurs and the cathode voltage VS thus decreases and falls below the threshold voltage Vth, the detection signal PFout is inverted from a low level to a high level. On the other hand, in a case where, as the avalanche multiplication of the SPAD 131 ends, the cathode voltage VS increases and becomes equal to or higher than the threshold voltage Vth, the detection signal PFout is inverted from the high level to the low level.

Note that, in a case where the pixel 81 is set as the inactive pixel, the inverted gating signal VG_I of Hi (1) is supplied to the switch 133, and the switch 133 is turned on. Once the switch 133 is turned on, the cathode voltage VS of the SPAD 131 becomes 0 V. As a result, the anode-cathode voltage of the SPAD 131 becomes equal to or lower than the breakdown voltage VBD, so that no reaction occurs even when photons enter the SPAD 131.

As described above, in the distance measurement pixel 81, the avalanche multiplication occurs once photons are incident. In the distance measurement pixel 81, as such avalanche multiplication is repeated, the characteristic such as the PDE, DCR, Vdb, or reaction delay time described above may be changed. In other words, the characteristic of the distance measurement pixel 81 may be changed depending on the number of reactions to photons due to incidence of the photons.

The observation pixel 101 observes the characteristic so that such a change in characteristic can be observed and a control according to the change in characteristic can be performed. Unlike the distance measurement pixel 81, the observation pixel 101 is configured in a state in which a light receiving surface side is shielded from light, and thus, is not configured such that photons are incident to the same extent as that of the distance measurement pixel 81 and the characteristic is changed depending on the number of reactions to the photons, and thus, there is a possibility that a difference occurs between the change in characteristic of the observation pixel 101 and the change in characteristic of the distance measurement pixel 81. The reason why the light receiving surface side of the observation pixel 101 is shielded from light is to prevent an unexpected SPAD reaction from occurring in the observation pixel 101 due to an influence of uncertain background light, and to appropriately control the SPAD reaction in the observation pixel 101 by the light emission of the observation pixel light emitting unit 107.

In order to correct such a difference, the observation apparatus 23 includes the observation pixel light emitting unit 107, and as the observation pixel light emitting unit 107 irradiates the observation pixel 101 with light, processing of changing the characteristic so as to match the characteristic changed according to the number of reactions to photons of the distance measurement pixel 81 is also performed in the observation pixel 101.

<Example of Cross Section of Pixel>

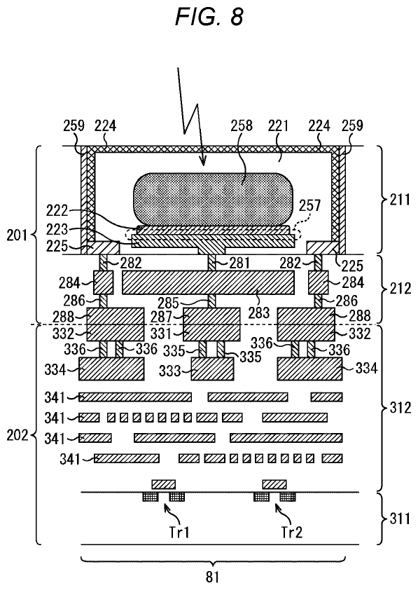

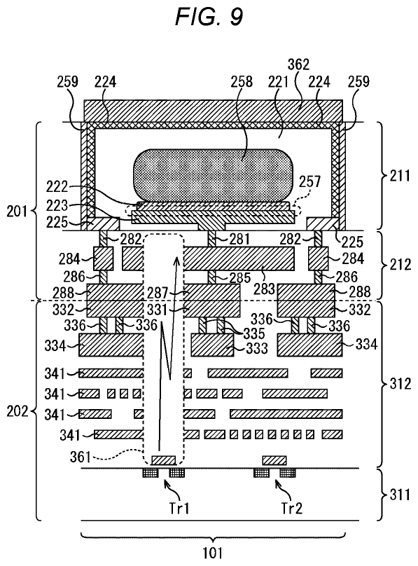

FIGS. 8 and 9 are cross-sectional views of the distance measurement pixel 81 and the observation pixel 101, respectively. FIG. 8 is a cross-sectional view of the distance measurement pixel 81, and FIG. 9 is a cross-sectional view of the observation pixel 101. The observation pixel 101 described with reference to FIG. 9 is provided in a case where the observation pixel light emitting unit 107 is provided in the observation apparatus 23 as described with reference to FIG. 3.

The distance measurement pixel 81 depicted in FIG. 8 is formed by bonding a first substrate 201 and a second substrate 202. The first substrate 201 includes a semiconductor substrate 211 formed using silicon or the like and a wiring layer 212. Hereinafter, the wiring layer 212 is referred to as a sensor-side wiring layer 212 for easy distinction from a wiring layer 312 of the second substrate 202 as described later. The wiring layer 312 of the second substrate 202 is referred to as a logic-side wiring layer 312. A surface of the semiconductor substrate 211 on which the sensor-side wiring layer 212 is formed is a front surface, and a back surface depicted on the upper side in the drawing and on which the sensor-side wiring layer 212 is not formed is a light receiving surface on which reflected light is incident.

A pixel region of the semiconductor substrate 211 includes an N-well 221, a P-type diffusion layer 222, an N-type diffusion layer 223, a hole accumulation layer 224, and a high-concentration P-type diffusion layer 225. Then, an avalanche multiplication region 257 is formed by a depletion layer formed in a region where the P-type diffusion layer 222 and the N-type diffusion layer 223 are connected.

The N-well 221 is formed by controlling an impurity concentration of the semiconductor substrate 211 to n-type and forms an electric field that transfers electrons generated by photoelectric conversion in the distance measurement pixel 81 to the avalanche multiplication region 257. In a central portion of the N-well 221, an N-type region 258 having a higher concentration than the N-well 221 is formed so as to be in contact with the P-type diffusion layer 222, and a potential gradient is formed so that carriers (electrons) generated in the N-well 221 easily drift from the periphery to the center. Note that, instead of the N-well 221, a P-well formed by controlling an impurity concentration of the semiconductor substrate 211 to p-type may be formed.

The P-type diffusion layer 222 is a high-concentration P-type diffusion layer (P+) formed over substantially the entire surface of the pixel region in a planar direction. The N-type diffusion layer 223 is a high-concentration N-type diffusion layer (N+) formed in the vicinity of the front surface of the semiconductor substrate 211 over substantially the entire surface of the pixel region, similarly to the P-type diffusion layer 222. The N-type diffusion layer 223 is a contact layer connected to a contact electrode 281 as a cathode electrode for supplying a negative voltage for forming the avalanche multiplication region 257, and has a protruding shape in which a part thereof is formed to reach the contact electrode 281 on the front surface of the semiconductor substrate 211.

The hole accumulation layer 224 is a P-type diffusion layer (P) formed so as to surround a side surface and a bottom surface of the N-well 221, and accumulates holes. In addition, the hole accumulation layer 224 is connected to the high-concentration P-type diffusion layer 225 electrically connected to a contact electrode 282 as an anode electrode of the SPAD 131.

The high-concentration P-type diffusion layer 225 is a high-concentration P-type diffusion layer (P++) formed so as to surround an outer periphery of the N-well 221 in the vicinity of the front surface of the semiconductor substrate 211, and constitutes a contact layer for electrically connecting the hole accumulation layer 224 to the contact electrode 282 of the SPAD 131.

A pixel isolation portion 259 that isolates pixels from each other is formed at a pixel boundary portion which is a boundary with respect to an adjacent pixel of the semiconductor substrate 211. For example, the pixel isolation portion 259 may include only an insulating layer or may have a two-layer structure in which an outer side (N-well 221 side) of a metal layer such as tungsten is covered with an insulating layer such as SiO2.

The contact electrodes 281 and 282, metal wirings 283 and 284, contact electrodes 285 and 286, and metal wirings 287 and 288 are formed in the sensor-side wiring layer 212.

The contact electrode 281 connects the N-type diffusion layer 223 and the metal wiring 283, and the contact electrode 282 connects the high-concentration P-type diffusion layer 225 and the metal wiring 284.

The metal wiring 283 is formed to be wider than the avalanche multiplication region 257 so as to cover at least the avalanche multiplication region 257 in a planar region. In addition, the metal wiring 283 may have a structure in which light transmitted through the pixel region of the semiconductor substrate 211 is reflected toward the semiconductor substrate 211 side.

The metal wiring 284 is formed so as to overlap with the high-concentration P-type diffusion layer 225 and surround an outer periphery of the metal wiring 283 in the planar region.

The contact electrode 285 connects the metal wiring 283 and the metal wiring 287, and the contact electrode 286 connects the metal wiring 284 and the metal wiring 288.

On the other hand, the second substrate 202 includes a semiconductor substrate 311 formed using silicon or the like, and a wiring layer 312 (logic-side wiring layer 312).

A plurality of MOS transistors Tr (Tr1, Tr2, and the like) and the logic-side wiring layer 312 are formed on a front surface side of the semiconductor substrate 311 that is the upper side in the drawing.

The logic-side wiring layer 312 includes metal wirings 331 and 332, metal wirings 333 and 334, and contact electrodes 335 and 336.

The metal wiring 331 is electrically and physically connected to the metal wiring 287 of the sensor-side wiring layer 212 by metal bonding such as Cu—Cu bonding. The metal wiring 332 is electrically and physically connected to the metal wiring 288 of the sensor-side wiring layer 212 by metal bonding such as Cu—Cu bonding or the like.

The contact electrode 335 connects the metal wiring 331 and the metal wiring 333, and the contact electrode 336 connects the metal wiring 332 and the metal wiring 334.

The logic-side wiring layer 312 further includes a plurality of layers of metal wirings 341 between a layer including the metal wirings 333 and 334 and the semiconductor substrate 311.

In the second substrate 202, logic circuits corresponding to the pixel driving unit 71, the MUX 73, the time measurement unit 74, the signal processing unit 75, and the like are formed by a plurality of MOS transistors Tr formed in the semiconductor substrate 311 and a plurality of layers of metal wiring 341.

For example, the power supply voltage VE applied to the N-type diffusion layer 223 via the logic circuits formed in the second substrate 202 is supplied to the N-type diffusion layer 223 via the metal wiring 333, the contact electrode 335, the metal wirings 331 and 287, the contact electrode 285, the metal wiring 283, and the contact electrode 281. In addition, the power supply voltage VA is supplied to the high-concentration P-type diffusion layer 225 via the metal wiring 334, the contact electrode 336, the metal wirings 332 and 288, the contact electrode 286, the metal wiring 284, and the contact electrode 282. Note that, in a case where the P-well formed by controlling the impurity concentration of the semiconductor substrate 211 to p-type is formed instead of the N-well 221, the voltage applied to the N-type diffusion layer 223 is the power supply voltage VA, and the voltage applied to the high-concentration P-type diffusion layer 225 is the power supply voltage VE.

A cross-sectional structure of the distance measurement pixel 81 for distance measurement is configured as described above, the SPAD 131 as a light receiving element includes the N-well 221 of the semiconductor substrate 211, the P-type diffusion layer 222, the N-type diffusion layer 223, the hole accumulation layer 224, and the high-concentration P-type diffusion layer 225, the hole accumulation layer 224 is connected to the contact electrode 282 as the anode electrode, and the N-type diffusion layer 223 is connected to the contact electrode 281 as the cathode electrode.

At least one layer of the metal wiring 283, 284, 287, 288, 331, 332, 333, 334, or 341 as a light shielding member is arranged between the semiconductor substrate 211 of the first substrate 201 and the semiconductor substrate 311 of the second substrate 202 in the entire region of the distance measurement pixel 81 in the planar direction. As a result, even in a case where light is emitted by hot carriers of the MOS transistors Tr of the semiconductor substrate 311 of the second substrate 202, the light does not reach the N-well 221 and the N-type region 258 of the semiconductor substrate 211 which are photoelectric conversion regions.

In the distance measurement pixel 81, the SPAD 131 as the light receiving element has a light receiving surface including flat surfaces of the N-well 221 and the hole accumulation layer 224, and the MOS transistor Tr as a light emitting source that performs hot carrier light emission is provided on a side of the SPAD 131 that is opposite to the light receiving surface. Then, the metal wiring 283 or 341 as the light shielding member is provided between the SPAD 131 as the light receiving element and the MOS transistor Tr as the light emitting source, and light emitted by hot carriers does not reach the N-well 221 or the N-type region 258 of the semiconductor substrate 211 as the photoelectric conversion region.

FIG. 9 illustrates a cross-sectional view of the observation pixel 101.

In FIG. 9, portions corresponding to those in FIG. 8 are denoted by the same reference signs, and a description of the portions is omitted as appropriate.

A cross-sectional structure of the observation pixel 101 for observation depicted in FIG. 9 is different from the distance measurement pixel 81 for distance measurement depicted in FIG. 8 in that a light guide portion 361 that propagates light (photons) by the hot carrier light emission is provided between the SPAD 131 as the light receiving element and the MOS transistor Tr as the light emitting source that performs the hot carrier light emission.

That is, a region where none of the metal wirings 283, 284, 287, 288, 331 to 334, and 341 that block light is formed is provided in a part of the entire region in the planar direction between the semiconductor substrate 211 of the first substrate 201 of the observation pixel 101 and the semiconductor substrate 311 of the second substrate 202, and the light guide portion 361 that propagates light is formed in a stacking direction of the metal wirings.

As a result, once the hot carrier light emission occurs in the MOS transistor Tr1 formed at a position at least partially overlapping with the light guide portion 361 in the planar direction, the SPAD 131 of the observation pixel 101 can receive light by the hot carrier light emission passing through the light guide portion 361 and output the detection signal (pixel signal). Note that, even in a case where not all the metal wirings 283 and 341 and the like are completely opened as described above, it is sufficient if the light guide portion 361 is opened to the extent that light can pass.

Furthermore, a light shielding member (light shielding layer) 362 is formed on an upper surface of the hole accumulation layer 224 on the light receiving surface side of the observation pixel 101 so as to cover a light receiving surface of the hole accumulation layer 224. The light shielding member 362 blocks disturbance light or the like incident from the light receiving surface side. Note that, as described above, since an influence of the disturbance light or the like can be removed by histogram generation processing, the light shielding member 362 is not essential and can be omitted.

The MOS transistor Tr1 that emits light propagating through the light guide portion 361 and reaching the photoelectric conversion region of the observation pixel 101 may be a MOS transistor provided as a circuit element that is not included in the distance measurement pixel 81 for distance measurement as the light emitting source, or may be a MOS transistor formed also in the distance measurement pixel 81 for distance measurement.

The observation pixel light emitting unit 107 that emits light to the observation pixel 101 can include the light guide portion 361 and the MOS transistor Tr1. In addition, the light emission control unit 106 functions as a control unit that controls the hot carrier light emission of the MOS transistor Tr1.

In a case where the MOS transistor Tr1 is specially provided as the light emitting source in the observation pixel 101 for observation, a circuit in the pixel region formed in the second substrate 202 is different between the distance measurement pixel 81 for observation and the distance measurement pixel 81 for distance measurement. In this case, the MOS transistor Tr1 specially provided as the light emitting source corresponds to, for example, a circuit that controls the light emitting source.

The observation pixel 101 for observation can be used to appropriately check a voltage applied to the SPAD 131. In this case, in the observation pixel 101, the MOS transistor Tr1 specially provided as the light emitting source is caused to emit light, the cathode voltage VS of the SPAD 131 at the time of the quenching operation, that is, the cathode voltage VS at time t2 in FIG. 7 can be checked and used to adjust the anode voltage VA.

On the other hand, in a case where the MOS transistor Tr1 as the light emitting source is a MOS transistor formed also in the distance measurement pixel 81 for distance measurement, a circuit in the pixel region formed in the second substrate 202 can be the same between the distance measurement pixel 81 for observation and the distance measurement pixel 81 for distance measurement.

Note that the light emitting source of the observation pixel 101 for observation is not limited to the MOS transistor, and may be other circuit elements such as a diode and a resistance element.

In addition, although the light receiving apparatus 52 is configured to have a stacked structure in which the first substrate 201 and the second substrate 202 are bonded together as described above, the light receiving apparatus 52 may also include one substrate (semiconductor substrate) or may be configured to have a stacked structure of three or more substrates. Moreover, although a back surface type light receiving sensor structure in which a back surface side that is opposite to the front surface of the first substrate 201 on which the sensor-side wiring layer 212 is formed is the light receiving surface is adopted, a front surface type light receiving sensor structure may also be adopted.

The observation pixel 101 depicted in FIG. 9 is provided in a case where the observation pixel light emitting unit 107 is provided in the observation apparatus 23 as described with reference to FIG. 3. In a case where the observation pixel light emitting unit 107′ is provided outside the observation apparatus 23 as described with reference to FIG. 4, the observation pixel 101 can have a configuration similar to that of the distance measurement pixel 81 described with reference to FIG. 8.

<First Processing Related to Characteristic Control>

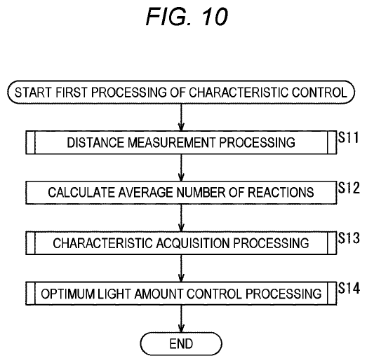

First processing related to a characteristic control performed by the distance measurement system 11 will be described with reference to flowcharts of FIGS. 10 to 13.

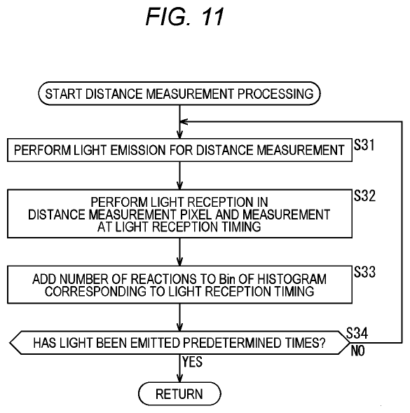

In Step S11, distance measurement processing is performed. This distance measurement processing is processing of measuring a distance to a subject, and distance measurement processing performed using the conventional SPAD 131 (FIG. 6) can be applied. Here, a description of the processing related to the characteristic control will be provided with reference to FIG. 11 together with a brief description of the distance measurement processing.

In Step S31, light emission for distance measurement is performed. The light emission control unit 31 controls the light emitting unit 32 to emit light in a predetermined pattern.

In Step S32, the light receiving apparatus 52 measures light reception in the distance measurement pixel 81 at a light reception timing. Furthermore, in Step S33, the number of reactions is added to a bin of the histogram that corresponds to the light reception timing.

The light receiving apparatus 52 is configured as depicted in FIG. 2 and includes the pixel array 72 in which a plurality of distance measurement pixels 81 is two-dimensionally arranged. The pixel driving unit 71 performs a control such that at least some of the plurality of distance measurement pixels 81 two-dimensionally arranged in a matrix form are set as the active pixels and the remaining distance measurement pixels 81 are set as the inactive pixels at a predetermined timing corresponding to the light emission timing signal supplied from the outside.

The active pixel is a pixel that detects incidence of photons, and the inactive pixel is a pixel that does not detect incidence of photons. The pixel signal generated by the active pixel in the pixel array 72 is input to the time measurement unit 74. On the basis of the pixel signal supplied from the active pixel of the pixel array 72 and the light emission timing signal indicating the light emission timing of the light emitting unit 32, the time measurement unit 73 generates a count value corresponding to a time from when the light emitting unit 32 emits light to when the active pixel receives light. The light emission timing signal is supplied from the outside to the time measurement unit 74 via the input/output unit 76.

The signal processing unit 75 creates, on the basis of the light emission of the light emitting unit 32 repeatedly performed a predetermined number of times (for example, several thousands to several tens of thousands of times) and the reception of the reflected light, a histogram of a count value obtained by counting a time until the reflected light is received for each pixel. Then, by detecting a peak of the histogram, the signal processing unit 75 determines a time until the light emitted from the light emitting unit 32 is reflected from the subject 12 or the subject 13 (FIG. 1) and returns. The signal processing unit 75 calculates a distance to an object on the basis of a digital count value obtained by counting a time until the light receiving apparatus 52 receives light and the speed of light.

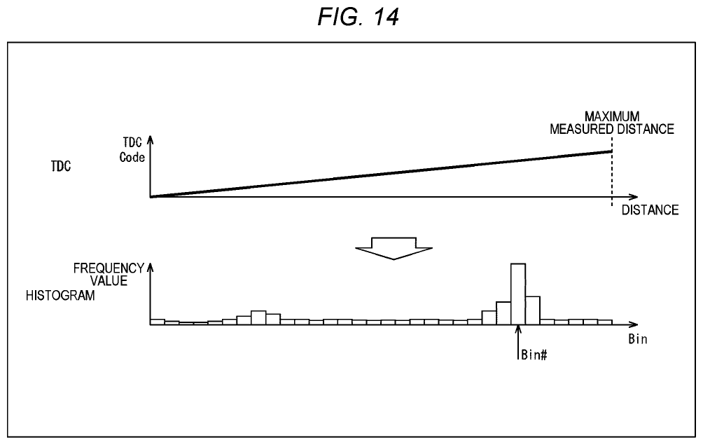

Time measurement performed by the time measurement unit 74 and generation of the histogram performed by the signal processing unit 75 will be described with reference to FIG. 14. The time measurement unit 74 includes a TDC clock generation unit (not illustrated) that generates a TDC clock signal. Furthermore, the time measurement unit 74 also includes a TDC that counts a time.

The TDC clock signal is a clock signal for TDC to count a time from when the light emitting unit 32 emits irradiation light to when the distance measurement pixel 81 receives the irradiation light. The TDC counts a time on the basis of the output from the MUX 73, and supplies a count value obtained as a result thereof to the signal processing unit 75. Hereinafter, a value counted by a TDC 112 is referred to as a TDC code.

The TDC counts up the TDC codes in order from 0 on the basis of the TDC clock signal. Then, the counting-up is stopped when the detection signal PFout input from the MUX 73 indicates a timing at which light is incident on the SPAD 131, and the TDC code in a final state is output to the signal processing unit 75.

In this manner, as depicted in FIG. 14, the time measurement unit 74 counts up the TDC codes on the basis of the TDC clock signal with the start of the light emission of the light emitting unit 32 as zero, and stops the counting-up when light is incident on the active pixel and the detection signal PFout of Hi is input from the MUX 73 to the time measurement unit 74.

The signal processing unit 75 acquires the TDC code in the final state, and increases a frequency value of a bin of a histogram corresponding to the TDC code by 1. As a result of repeating the light emission of the light emitting unit 32 and the reception of the reflected light a predetermined number of times (for example, several thousands to several tens of thousands of times), the histogram indicating frequency distribution of the TDC codes as depicted on the lower side of FIG. 14 is completed in the signal processing unit 75.

In the example of FIG. 14, a TDC code corresponding to a bin indicated by Bin # with the maximum frequency value is supplied from the signal processing unit 75 to a subsequent processing unit, for example, a distance calculation unit (not illustrated) that calculates a distance.

The distance calculation unit (not illustrated) detects, for example, a TDC code having the maximum frequency value (peak) in the generated histogram. The distance calculation unit calculates a distance to an object by performing calculation to obtain the distance to the object on the basis of the TDC code having the peak value and the speed of light.

Distance measurement is performed by performing such processing in Steps S31 to S33. Note that, although not depicted in the flowchart of FIG. 11, after the processing of Step S33, the above-described calculation performed by the distance calculation unit is performed as distance measurement processing, and a distance to a predetermined object is calculated.

Returning to the description with reference to the flowchart of FIG. 11, in Step S34, it is determined whether or not the light emitting unit 32 has emitted light a predetermined number of times. When the number of times the light emitting unit 32 has emitted light reaches the predetermined number of times, subsequent processing (here, processing after Step S12 in FIG. 10) is performed, and characteristic observation is performed.

Until it is determined in Step S34 that the light emitting unit 32 has emitted light the predetermined number of times, the processing returns to Step S31, and processing related to distance measurement is performed. On the other hand, in a case where it is determined in Step S34 that the light emitting unit 32 has emitted light the predetermined number of times, the processing proceeds to Step S12 (FIG. 10).

In Step S12, the average number of reactions is calculated. The average number of reactions is an average value of the number of reactions of each of a plurality of (for example, M×N (M≥1 and N≥1)) distance measurement pixels 81 arranged in the pixel array 72. The received photon counter 104 of the observation apparatus 23 depicted in FIG. 3 counts the number of reactions in each distance measurement pixel 81 by using the output from the MUX 73, and calculates the average value.

A signal from the MUX 73 included in the light receiving apparatus 52 is supplied to the received photon counter 104. The MUX 73 selects an output from the active pixel according to switching between the active pixel and the inactive pixel in the pixel array 72. Therefore, a pixel signal input from the selected active pixel is output from the MUX 73, and the pixel signal is supplied to the received photon counter 104 of the observation apparatus 23.

As described above, the output signal from the active pixel is the detection signal PFout of Hi that is output once light is incident on the active pixel. That is, since the received photon counter 104 receives a signal output once light is received, the received photon counter 104 can count the number of reactions to the incident light in the distance measurement pixel 81. The received photon counter 104 calculates an average value of the number of reactions of the distance measurement pixel 81.

The number of reactions may be acquired from all (M×N) distance measurement pixels 81 arranged in the pixel array 72, and an average value of the number of reactions of all the distance measurement pixels 81 may be calculated. Alternatively, the number of reactions may be acquired from a predetermined number of distance measurement pixels 81 among the distance measurement pixels 81 arranged in the pixel array 72, and an average value of the number of reactions of the predetermined number of distance measurement pixels 81 may be used as the average value of the number of reactions of all the distance measurement pixels 81.

In addition, here, the description will be continued assuming that the average value of the number of reactions is calculated, but the maximum value or minimum value of the number of reactions may be extracted. For example, the maximum value may be extracted from the number of reactions of all (M×N) distance measurement pixels 81 arranged in the pixel array 72, and the maximum value may be used for subsequent processing. In a case of using the maximum value of the number of reactions, a control is performed in accordance with the distance measurement pixel 81 whose characteristic is assumed to change (deteriorate) the most among the distance measurement pixels 81.

Furthermore, for example, the minimum value may be extracted from the number of reactions of all the distance measurement pixels 81 arranged in the pixel array 72, and the minimum value may be used for subsequent processing. In a case of using the minimum value of the number of reactions, a control is performed in accordance with the distance measurement pixel 81 whose characteristic is assumed to be unchanged (undeteriorated) the most among the distance measurement pixels 81.

Furthermore, for example, the maximum value and the minimum value may be extracted from the number of reactions of all the distance measurement pixels 81 arranged in the pixel array 72, and a median of the maximum value and the minimum value may be used for subsequent processing. Furthermore, instead of using the number of reactions of the distance measurement pixel 81 as it is, for example, a value obtained after conversion into a value obtained after temporal filtering may be used.

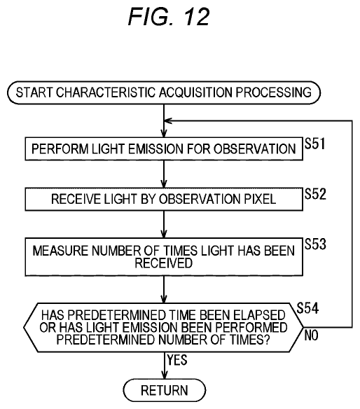

Once the average number of reactions of the distance measurement pixel 81 is calculated in Step S12, the processing proceeds to Step S13. In Step S13, characteristic acquisition processing is performed. The characteristic acquisition processing is performed by the observation apparatus 23. The characteristic acquisition processing performed in Step S13 will be described with reference to the flowchart of FIG. 12.

In Step S51, light emission for observation is performed. The light emission for observation is processing in which the light emission control unit 106 of the observation apparatus 23 controls the observation pixel light emitting unit 107 to irradiate only the observation pixel 101 with light.

Once light emission is performed by the observation pixel light emitting unit 107, the observation pixel 101 receives the light emitted from the observation pixel light emitting unit 107 in Step S52.

In Step S53, the number of times light has been received by the observation pixel 101 (the number of reactions caused by input of photons) is measured. The observed photon counter 103 measures the number of times light has been received by the observation pixel 101 (the number of reactions). A basic configuration of the observation pixel 101 is similar to that of the distance measurement pixel 81, and the observation pixel 101 has, for example, the circuit configuration depicted in FIG. 6. Therefore, the observation pixel 101 can also be configured to output the detection signal PFout of Hi to the observed photon counter 103 once light is received. Then, the observed photon counter 103 measures the number of reactions to the input photons in the observation pixel 101 (the number of times the photons have been received).

In Step S54, it is determined whether or not a predetermined time has elapsed or whether or not light emission has been performed a predetermined number of times. Time measurement is started from a time point when light emission of the observation pixel light emitting unit 107 starts, and it is determined whether or not a measured time has reached a predetermined time. Alternatively, counting of the number of times light emission has been performed (the number of times of turning on or off) is started from a time point when light emission of the observation pixel light emitting unit 107 starts, and it is determined whether or not the counted number of times has reached a predetermined number of times.

The determination in Step S54 may be made on the basis of whether or not the predetermined time has elapsed or on the basis of whether or not light emission has been performed the predetermined number of times. Here, the description will be continued assuming that it is determined whether or not light emission has been performed the predetermined number of times.

The processing returns to Step S51, and the subsequent processing is repeated until it is determined in Step S54 that light emission has been performed the predetermined number of times. By repeating the processing of Steps S51 to S54, an influence on the distance measurement pixel 81 is reproduced in a pseudo manner for the observation pixel 101.

The observation pixel 101 is provided in a state of being shielded from light and is provided in a state of being not affected by external light. On the other hand, the distance measurement pixel 81 is provided in a state of receiving external light, and is provided in a state of being affected by external light. Furthermore, the characteristic of the distance measurement pixel 81 may change due to an influence of external light. In order to observe a change in characteristic in the distance measurement pixel 81, it is necessary to consider an influence of external light on the distance measurement pixel 81 also in the observation pixel 101. Therefore, as described above, processing for reproducing an influence on the distance measurement pixel 81 in a pseudo manner for the observation pixel 101 is performed by irradiating the observation pixel 101 with light emitted by the observation pixel light emitting unit 107.

The observation pixel 101 is irradiated with the light emitted by the observation pixel light emitting unit 107 a predetermined number of times, and this predetermined number of times is the number of times set in optimum light amount control processing in Step S14 described later. That is, the predetermined number of times is the number of times set when the first processing of the previous characteristic control is performed.

In a case where it is determined in Step S54 that light emission of the observation pixel light emitting unit 107 has been performed the predetermined number of times, the processing proceeds to Step S14 (FIG. 10). Note that, although not depicted in FIG. 12, the sensor characteristic observation unit 102 of the observation apparatus 23 also counts the number of times light has been received by the observation pixel 101 and measures the characteristic of the pixel. Furthermore, a bias voltage to be applied to the distance measurement pixel 81 is set on the basis of the measured characteristic.

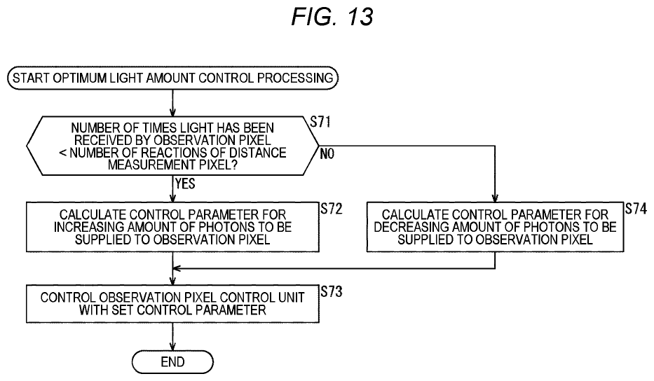

In Step S14, the optimum light amount control processing is performed. The optimum light amount control processing performed in Step S14 will be described with reference to the flowchart of FIG. 13.

In Step S71, it is determined whether or not the number of times light has been received by the observation pixel 101 is smaller than the number of reactions of the distance measurement pixel 81. The number of times light has been received by the observation pixel 101 is supplied from the observed photon counter 103 to the photon number comparison unit 105 (FIG. 3), and the number of reactions of the distance measurement pixel 81 is supplied from the received photon counter 104. The photon number comparison unit 105 compares the number of times light has been received by the observation pixel 101 and the number of reactions of the distance measurement pixel 81 that are supplied, and determines whether or not the number of times light has been received by the observation pixel 101 is smaller than the number of reactions of the distance measurement pixel 81.

In a case where the photon number comparison unit 105 determines in Step S71 that the number of times light has been received by the observation pixel 101 (the number of reactions) is smaller than the number of reactions of the distance measurement pixel 81, the processing proceeds to Step S72.

Note that, in a case where the number of times light has been received by the observation pixel 101 and the number of reactions of the distance measurement pixel 81 are the same, the processing may proceed to Step S72, or the processing may proceed to Step S74 described later.

In Step S72, a control parameter for increasing the amount of photons to be supplied to the observation pixel 101 is calculated. It is considered that it is determined that the number of times light has been received by the observation pixel 101 is smaller than the number of reactions of the distance measurement pixel 81 in a case where the characteristic of the observation pixel 101 is more favorable than the characteristic of the distance measurement pixel 81. In a case where the change in characteristic of the distance measurement pixel 81 is expressed as deterioration, it is considered that it is determined that the number of times light has been received by the observation pixel 101 is smaller than the number of reactions of the distance measurement pixel 81 in a case where the observation pixel 101 is not deteriorated as compared with the distance measurement pixel 81.

Therefore, in order to match the deterioration of the observation pixel 101 with the deterioration of the distance measurement pixel 81, the control parameter for increasing the amount of photons to be supplied to the observation pixel 101 is set. That is, by irradiating the observation pixel 101 with more light, a parameter for deteriorating the observation pixel 101 to the same extent as the deterioration of the distance measurement pixel 81 is set.

The control parameter may be set by the photon number comparison unit 105 or may be set by the light emission control unit 106. In a case where the photon number comparison unit 105 sets the control parameter, the photon number comparison unit 105 calculates the control parameter, and the calculated control parameter is supplied to the light emission control unit 106. In a case where the light emission control unit 106 sets the control parameter, the determination result in Step S71 is supplied from the photon number comparison unit 105 to the light emission control unit 106, and the light emission control unit 106 calculates the control parameter on the basis of the supplied determination result.

The control parameter for increasing the amount of photons to be supplied is a parameter for controlling a light emission frequency or a light emission intensity of the observation pixel light emitting unit 107 (FIG. 3). In a case where the observation pixel light emitting unit 107′ is provided outside the observation apparatus 23 as in the observation apparatus 23 depicted in FIG. 4, a parameter for controlling a light emission frequency or a light emission intensity of the observation pixel light emitting unit 107′ are set.

The amount of photons to be supplied to the observation pixel 101 can be increased by increasing the light emission frequency of the observation pixel light emitting unit 107, in other words, by increasing a cycle of a light emission pattern. Similarly, the amount of photons to be supplied to the observation pixel 101 can be increased by increasing the light emission intensity of the observation pixel light emitting unit 107. In order to increase the amount of photons to be supplied to the observation pixel 101, the light emission frequency may be increased or the light emission intensity may be increased.

The light emission frequency or light emission intensity of the observation pixel light emitting unit 107 (107′) may be set according to a difference value between the number of reactions of the observation pixel 101 and the number of reactions of the distance measurement pixel 81. In a case where the difference value is large, a control parameter for greatly changing the light emission frequency or light emission intensity can be set, and in a case where the difference value is small, a control parameter for slightly changing the light emission frequency or light emission intensity can be set.

Once the control parameter is set in Step S72, the processing proceeds to Step S73. In Step S73, the observation pixel light emitting unit 10 is controlled according to the set control parameter. This control is performed when the characteristic acquisition processing depicted in FIG. 12 is performed after the control parameter is set.

In addition, it is determined in Step S54 of the characteristic acquisition processing depicted in FIG. 12 whether or not light emission has been performed the predetermined number of times, and the predetermined number of times is set as the number of times based on the control parameter set in Step S72. Alternatively, light emission for observation is performed in Step S51 of the characteristic acquisition processing depicted in FIG. 12, and the light emission intensity at the time of the light emission for observation is set as an intensity based on the control parameter set in Step S72.

In a case where it is determined in Step S54 whether or not the predetermined time has elapsed, the control parameter set in Step S72 is a light emission time. Furthermore, the light emission time to be set may be a time calculated from the number of times light emission is performed and the light emission pattern (cycle) after the number of times light emission is performed is set.

On the other hand, in a case where the photon number comparison unit 105 determines in Step S71 that the number of times light has been received by the observation pixel 101 is larger than the number of reactions of the distance measurement pixel 81, the processing proceeds to Step S74.

In Step S74, a control parameter for decreasing the amount of photons to be supplied to the observation pixel 101 is calculated. It is considered that it is determined that the number of times light has been received by the observation pixel 101 is larger than the number of reactions of the distance measurement pixel 81 in a case where the observation pixel 101 is deteriorated as compared with the distance measurement pixel 81. Therefore, in order to match the deterioration of the observation pixel 101 with the degradation of the distance measurement pixel 81, the control parameter for decreasing the amount of photons to be supplied to the observation pixel 101 is set so that the observation pixel 101 is not further deteriorated.

Similarly to the control parameter for increasing the amount of photons to be supplied, the control parameter for decreasing the amount of photons to be supplied is also a parameter for controlling the light emission frequency or the light emission intensity of the observation pixel light emitting unit 107 (FIG. 3). The amount of photons to be supplied to the observation pixel 101 can be decreased by decreasing the light emission frequency of the observation pixel light emitting unit 107, in other words, by decreasing the cycle of the light emission pattern. Similarly, the amount of photons to be supplied to the observation pixel 101 can be decreased by decreasing the light emission intensity of the observation pixel light emitting unit 107. In order to decrease the amount of photons to be supplied to the observation pixel 101, the light emission frequency may be decreased or the light emission intensity may be decreased.

Note that a parameter that does not cause the observation pixel light emitting unit 107 to emit light may be set as the control parameter. For example, in a case where a difference value between the number of times light has been received by the observation pixel 101 and the number of reactions of the distance measurement pixel 81 is a predetermined value or more, the parameter that does not cause the observation pixel light emitting unit 107 to emit light may be set.

Once the control parameter is set in Step S72, the processing proceeds to Step S73. Since the processing in Step S73 is similar to that in a case already described, a description thereof is omitted here.

Once the processing of Step S73 ends, the first processing of the characteristic control depicted in FIG. 10 also ends. In this manner, processing for matching the characteristic of the observation pixel 101 with the characteristic of the distance measurement pixel 81 is performed.

As such, for example, the bias voltage applied to the SPAD 131 is controlled in a state in which the characteristic of the observation pixel 101 and the characteristic of the distance measurement pixel 81 are matched, so that an appropriate control can be performed.

<Second Processing Related to Characteristic Control>

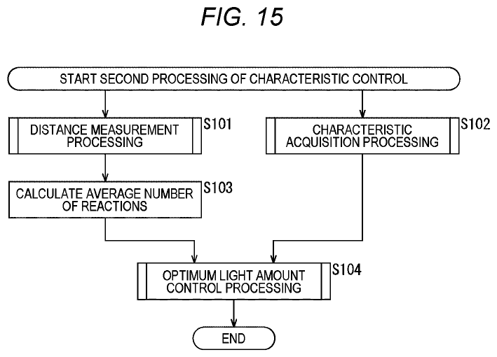

Second processing related to the characteristic control performed by the distance measurement system 11 will be described with reference to flowchart of FIG. 15.

In the first processing related to the characteristic control described above, a case where the distance measurement processing is performed in the processing performed by the light emitting apparatus 21, the image pickup unit 41, and the like, and then the characteristic acquisition processing is performed in the observation apparatus 23 has been described as an example. The distance measurement processing and the characteristic acquisition processing may be performed in parallel. That is, as in the flowchart of FIG. 15, the distance measurement processing may be performed in Step S101, and the characteristic acquisition processing may also be performed in Step S102.

Since the distance measurement processing in Step S101 can be performed similarly to that in the description with reference to the processing in the flowchart of FIG. 11, a description thereof is omitted here. In addition, since the characteristic acquisition processing in Step S102 can be performed similarly to that in the description with reference to the processing in the flowchart of FIG. 12, a description thereof is omitted here.

The distance measurement processing and the characteristic acquisition processing are performed in parallel. Note that, although it has been described that the distance measurement processing and the characteristic acquisition processing are performed in parallel, it is not always necessary to perform the characteristic acquisition processing when the distance measurement processing is performed, and for example, the characteristic acquisition processing may be performed every predetermined cycle. The distance measurement processing and the characteristic acquisition processing may be performed independently at individual timings.

In Step S101, the distance measurement processing is performed, and in a case where it is determined that light emission has been performed a predetermined number of times, the processing proceeds to Step S103. The processing of Step S103 is processing similar to the processing of Step S12 (FIG. 10), and is processing of calculating an average of the number of reactions of the distance measurement pixel 81. Once the average of the number of reactions of the distance measurement pixel 81 is calculated in Step S103, the processing proceeds to Step S104.

In Step S104, the optimum light amount control processing is performed. Since this optimum light amount control processing can be performed similarly to that in the description with reference to the processing in the flowchart of FIG. 13, a description thereof is omitted here.

As described above, the observation processing (characteristic acquisition processing) performed by the observation apparatus 23 may be performed regardless of the distance measurement processing, and the optimum light amount control processing may be performed at a predetermined timing. The predetermined timing can be, for example, a timing at which the average number of reactions of the distance measurement pixel 81 is calculated in Step S103, each preset cycle, or the like.

According to the present technology, since the characteristic of the observation pixel 101 that observes the characteristic can also be changed in accordance with the change in characteristic of the distance measurement pixel, it is possible to perform an appropriate control in accordance with the change in characteristic of the distance measurement pixel.

<Example of Application to Endoscopic Surgery System>

The technology according to an embodiment of the present disclosure (present technology) can be applied to various products. For example, the technology according to an embodiment of the present disclosure may be applied to an endoscopic surgery system.

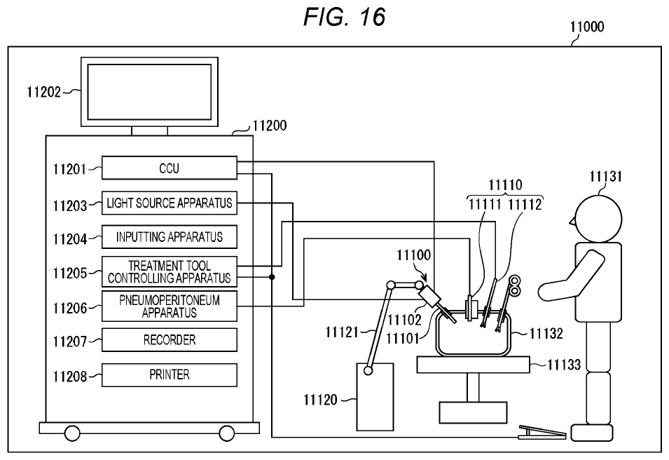

FIG. 16 is a view depicting an example of a schematic configuration of an endoscopic surgery system to which the technology according to an embodiment of the present disclosure (present technology) can be applied.

In FIG. 16, a state is depicted in which a surgeon (medical doctor) 11131 is using an endoscopic surgery system 11000 to perform surgery for a patient 11132 on a patient bed 11133. As depicted, the endoscopic surgery system 11000 includes an endoscope 11100, other surgical tools 11110 such as a pneumoperitoneum tube 11111 and an energy device 11112, a supporting arm apparatus 11120 which supports the endoscope 11100 thereon, and a cart 11200 on which various apparatus for endoscopic surgery are mounted.

The endoscope 11100 includes a lens barrel 11101 having a region of a predetermined length from a distal end thereof to be inserted into a body cavity of the patient 11132, and a camera head 11102 connected to a proximal end of the lens barrel 11101. In the example depicted, the endoscope 11100 is depicted which includes as a rigid endoscope having the lens barrel 11101 of the hard type. However, the endoscope 11100 may otherwise be included as a flexible endoscope having the lens barrel 11101 of the flexible type.

The lens barrel 11101 has, at a distal end thereof, an opening in which an objective lens is fitted. A light source apparatus 11203 is connected to the endoscope 11100 such that light generated by the light source apparatus 11203 is introduced to a distal end of the lens barrel 11101 by a light guide extending in the inside of the lens barrel 11101 and is irradiated toward an observation target in a body cavity of the patient 11132 through the objective lens. It is to be noted that the endoscope 11100 may be a forward-viewing endoscope or may be an oblique-viewing endoscope or a side-viewing endoscope.

An optical system and an image pickup element are provided in the inside of the camera head 11102 such that reflected light (observation light) from the observation target is condensed on the image pickup element by the optical system. The observation light is photo-electrically converted by the image pickup element to generate an electric signal corresponding to the observation light, namely, an image signal corresponding to an observation image. The image signal is transmitted as RAW data to a Camera Control Unit (CCU) 11201.

The CCU 11201 includes a central processing unit (CPU), a graphics processing unit (GPU) or the like and integrally controls operation of the endoscope 11100 and a display apparatus 11202. Further, the CCU 11201 receives an image signal from the camera head 11102 and performs, for the image signal, various image processes for displaying an image based on the image signal such as, for example, a development process (demosaic process).

The display apparatus 11202 displays thereon an image based on an image signal, for which the image processes have been performed by the CCU 11201, under the control of the CCU 11201.

The light source apparatus 11203 includes a light source such as, for example, a light emitting diode (LED) and supplies irradiation light upon imaging of a surgical region to the endoscope 11100.

An inputting apparatus 11204 is an input interface for the endoscopic surgery system 11000. A user can perform inputting of various kinds of information or instruction inputting to the endoscopic surgery system 11000 through the inputting apparatus 11204. For example, the user would input an instruction or a like to change an image pickup condition (type of irradiation light, magnification, focal distance or the like) by the endoscope 11100.

A treatment tool controlling apparatus 11205 controls driving of the energy device 11112 for cautery or incision of a tissue, sealing of a blood vessel or the like. A pneumoperitoneum apparatus 11206 feeds gas into a body cavity of the patient 11132 through the pneumoperitoneum tube 11111 to inflate the body cavity in order to secure the field of view of the endoscope 11100 and secure the working space for the surgeon. A recorder 11207 is an apparatus capable of recording various kinds of information relating to surgery. A printer 11208 is an apparatus capable of printing various kinds of information relating to surgery in various forms such as a text, an image or a graph.

It is to be noted that the light source apparatus 11203 which supplies irradiation light when a surgical region is to be imaged to the endoscope 11100 may include a white light source which includes, for example, an LED, a laser light source or a combination of them. Where a white light source includes a combination of red, green, and blue (RGB) laser light sources, since the output intensity and the output timing can be controlled with a high degree of accuracy for each color (each wavelength), adjustment of the white balance of a picked up image can be performed by the light source apparatus 11203. Further, in this case, if laser beams from the respective RGB laser light sources are irradiated time-divisionally on an observation target and driving of the image pickup elements of the camera head 11102 are controlled in synchronism with the irradiation timings. Then images individually corresponding to the R, G and B colors can be also picked up time-divisionally. According to this method, a color image can be obtained even if color filters are not provided for the image pickup element.

Further, the light source apparatus 11203 may be controlled such that the intensity of light to be outputted is changed for each predetermined time. By controlling driving of the image pickup element of the camera head 11102 in synchronism with the timing of the change of the intensity of light to acquire images time-divisionally and synthesizing the images, an image of a high dynamic range free from underexposed blocked up shadows and overexposed highlights can be created.

Further, the light source apparatus 11203 may be configured to supply light of a predetermined wavelength band ready for special light observation. In special light observation, for example, by utilizing the wavelength dependency of absorption of light in a body tissue to irradiate light of a narrow band in comparison with irradiation light upon ordinary observation (namely, white light), narrow band observation (narrow band imaging) of imaging a predetermined tissue such as a blood vessel of a superficial portion of the mucous membrane or the like in a high contrast is performed. Alternatively, in special light observation, fluorescent observation for obtaining an image from fluorescent light generated by irradiation of excitation light may be performed. In fluorescent observation, it is possible to perform observation of fluorescent light from a body tissue by irradiating excitation light on the body tissue (autofluorescence observation) or to obtain a fluorescent light image by locally injecting a reagent such as indocyanine green (ICG) into a body tissue and irradiating excitation light corresponding to a fluorescent light wavelength of the reagent upon the body tissue. The light source apparatus 11203 can be configured to supply such narrow-band light and/or excitation light suitable for special light observation as described above.

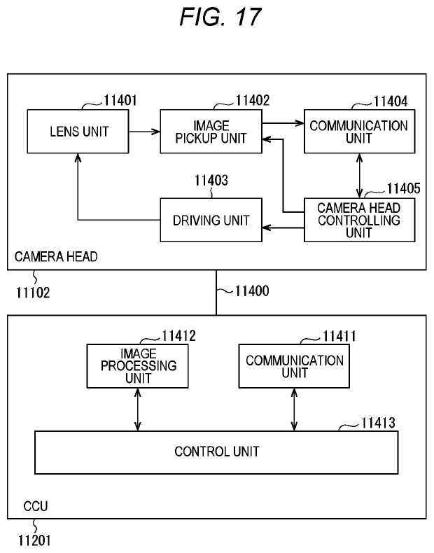

FIG. 17 is a block diagram depicting an example of a functional configuration of the camera head 11102 and the CCU 11201 depicted in FIG. 16.

The camera head 11102 includes a lens unit 11401, an image pickup unit 11402, a driving unit 11403, a communication unit 11404 and a camera head controlling unit 11405. The CCU 11201 includes a communication unit 11411, an image processing unit 11412 and a control unit 11413. The camera head 11102 and the CCU 11201 are connected for communication to each other by a transmission cable 11400.

The lens unit 11401 is an optical system, provided at a connecting location to the lens barrel 11101. Observation light taken in from a distal end of the lens barrel 11101 is guided to the camera head 11102 and introduced into the lens unit 11401. The lens unit 11401 includes a combination of a plurality of lenses including a zoom lens and a focusing lens.

The number of image pickup elements which is included by the image pickup unit 11402 may be one (single-plate type) or a plural number (multi-plate type). Where the image pickup unit 11402 is configured as that of the multi-plate type, for example, image signals corresponding to respective R, G and B are generated by the image pickup elements, and the image signals may be synthesized to obtain a color image. The image pickup unit 11402 may also be configured so as to have a pair of image pickup elements for acquiring respective image signals for the right eye and the left eye ready for three dimensional (3D) display. If 3D display is performed, then the depth of a living body tissue in a surgical region can be comprehended more accurately by the surgeon 11131. It is to be noted that, where the image pickup unit 11402 is configured as multi-plate type, a plurality of systems of lens units 11401 are provided corresponding to the individual image pickup elements.

Further, the image pickup unit 11402 may not necessarily be provided on the camera head 11102. For example, the image pickup unit 11402 may be provided immediately behind the objective lens in the inside of the lens barrel 11101.

The driving unit 11403 includes an actuator and moves the zoom lens and the focusing lens of the lens unit 11401 by a predetermined distance along an optical axis under the control of the camera head controlling unit 11405. Consequently, the magnification and the focal point of a picked up image by the image pickup unit 11402 can be adjusted suitably.

The communication unit 11404 includes a communication apparatus for transmitting and receiving various kinds of information to and from the CCU 11201. The communication unit 11404 transmits an image signal acquired from the image pickup unit 11402 as RAW data to the CCU 11201 through the transmission cable 11400.

In addition, the communication unit 11404 receives a control signal for controlling driving of the camera head 11102 from the CCU 11201 and supplies the control signal to the camera head controlling unit 11405. The control signal includes information relating to image pickup conditions such as, for example, information that a frame rate of a picked up image is designated, information that an exposure value upon image picking up is designated and/or information that a magnification and a focal point of a picked up image are designated.

It is to be noted that the image pickup conditions such as the frame rate, exposure value, magnification or focal point may be designated as needed by the user or may be set automatically by the control unit 11413 of the CCU 11201 on the basis of an acquired image signal. In the latter case, an auto exposure (AE) function, an auto focus (AF) function and an auto white balance (AWB) function are incorporated in the endoscope 11100.

The camera head controlling unit 11405 controls driving of the camera head 11102 on the basis of a control signal from the CCU 11201 received through the communication unit 11404.

The communication unit 11411 includes a communication apparatus for transmitting and receiving various kinds of information to and from the camera head 11102. The communication unit 11411 receives an image signal transmitted thereto from the camera head 11102 through the transmission cable 11400.

Further, the communication unit 11411 transmits a control signal for controlling driving of the camera head 11102 to the camera head 11102. The image signal and the control signal can be transmitted by electrical communication, optical communication or the like.

The image processing unit 11412 performs various image processes for an image signal in the form of RAW data transmitted thereto from the camera head 11102.

The control unit 11413 performs various kinds of control relating to image picking up of a surgical region or the like by the endoscope 11100 and display of a picked up image obtained by image picking up of the surgical region or the like. For example, the control unit 11413 creates a control signal for controlling driving of the camera head 11102.

Further, the control unit 11413 controls, on the basis of an image signal for which image processes have been performed by the image processing unit 11412, the display apparatus 11202 to display a picked up image in which the surgical region or the like is imaged. Thereupon, the control unit 11413 may recognize various objects in the picked up image using various image recognition technologies. For example, the control unit 11413 can recognize a surgical tool such as forceps, a particular living body region, bleeding, mist when the energy device 11112 is used and so forth by detecting the shape, color and so forth of edges of objects included in a picked up image. The control unit 11413 may cause, when it controls the display apparatus 11202 to display a picked up image, various kinds of surgery supporting information to be displayed in an overlapping manner with an image of the surgical region using a result of the recognition. Where surgery supporting information is displayed in an overlapping manner and presented to the surgeon 11131, the burden on the surgeon 11131 can be reduced and the surgeon 11131 can proceed with the surgery with certainty.

The transmission cable 11400 which connects the camera head 11102 and the CCU 11201 to each other is an electric signal cable ready for communication of an electric signal, an optical fiber ready for optical communication or a composite cable ready for both of electrical and optical communications.

Here, while, in the example depicted, communication is performed by wired communication using the transmission cable 11400, the communication between the camera head 11102 and the CCU 11201 may be performed by wireless communication.

[Example of Application to Mobile Body]

The technology according to an embodiment of the present disclosure (present technology) can be applied to various products. For example, the technology according to an embodiment of the present disclosure may be implemented as a device mounted in any one of mobile bodies such as a vehicle, an electric vehicle, a hybrid electric vehicle, a motorcycle, a bicycle, a personal mobility device, a plane, a drone, a ship, a robot, and the like.

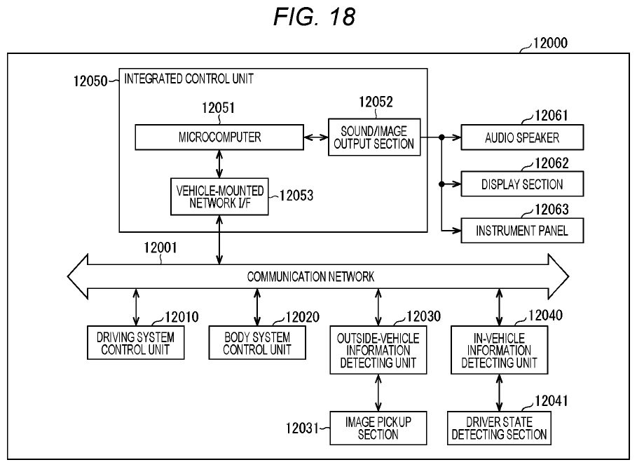

FIG. 18 is a block diagram depicting an example of a schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 18, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an image pickup section 12031. The outside-vehicle information detecting unit 12030 makes the image pickup section 12031 image the outside of the vehicle, and receives the picked up image. On the basis of the received image, the outside-vehicle information detecting unit 12030 may perform processing of detecting an object such as a human, a vehicle, an obstacle, a sign, a character on a road surface, or the like, or processing of detecting a distance thereto.

The image pickup section 12031 is an optical sensor that receives light, and which outputs an electric signal corresponding to a received light amount of the light. The image pickup section 12031 can output the electric signal as an image, or can output the electric signal as information about a measured distance. In addition, the light received by the image pickup section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12030 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 18, an audio speaker 12061, a display section 12062, and an instrument panel 12063 are illustrated as the output device. The display section 12062 may, for example, include at least one of an on-board display and a head-up display.

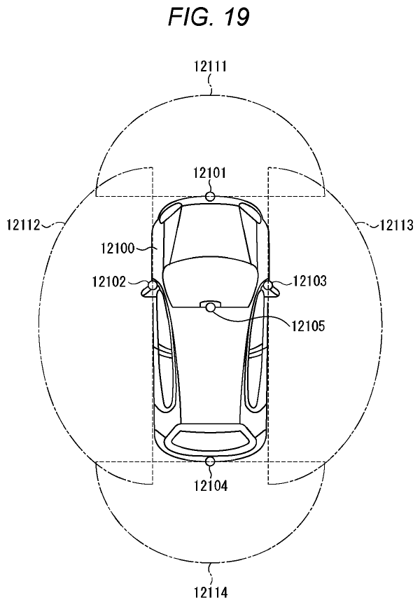

FIG. 19 is a diagram depicting an example of the installation position of the image pickup section 12031.

In FIG. 19, the image pickup section 12031 includes image pickup sections 12101, 12102, 12103, 12104, and 12105.

The image pickup sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The image pickup section 12101 provided to the front nose and the image pickup section 12105 provided to the upper portion of the windshield within the interior of the vehicle obtain mainly an image of the front of the vehicle 12100. The image pickup sections 12102 and 12103 provided to the sideview mirrors obtain mainly an image of the sides of the vehicle 12100. The image pickup section 12104 provided to the rear bumper or the back door obtains mainly an image of the rear of the vehicle 12100. The image pickup section 12105 provided to the upper portion of the windshield within the interior of the vehicle is used mainly to detect a preceding vehicle, a pedestrian, an obstacle, a signal, a traffic sign, a lane, or the like.

Incidentally, FIG. 19 depicts an example of photographing ranges of the image pickup sections 12101 to 12104. An image pickup range 12111 represents the image pickup range of the image pickup section 12101 provided to the front nose. image pickup ranges 12112 and 12113 respectively represent the image pickup ranges of the image pickup sections 12102 and 12103 provided to the sideview mirrors. An image pickup range 12114 represents the image pickup range of the image pickup section 12104 provided to the rear bumper or the back door. A bird's-eye image of the vehicle 12100 as viewed from above is obtained by superimposing image data imaged by the image pickup sections 12101 to 12104, for example.

At least one of the image pickup sections 12101 to 12104 may have a function of obtaining distance information. For example, at least one of the image pickup sections 12101 to 12104 may be a stereo camera constituted of a plurality of imaging elements, or may be an imaging element having pixels for phase difference detection.

For example, the microcomputer 12051 can determine a distance to each three-dimensional object within the image pickup ranges 12111 to 12114 and a temporal change in the distance (relative speed with respect to the vehicle 12100) on the basis of the distance information obtained from the image pickup sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the image pickup sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the image pickup sections 12101 to 12104 may be an infrared camera that detects infrared rays. The microcomputer 12051 can, for example, recognize a pedestrian by determining whether or not there is a pedestrian in picked up images of the image pickup sections 12101 to 12104. Such recognition of a pedestrian is, for example, performed by a procedure of extracting characteristic points in the picked up images of the image pickup sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the picked up images of the image pickup sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

In the present specification, the system represents the entire apparatus including a plurality of apparatus.

Note that the effects described in the present specification are merely illustrative and not limitative, and the present technology may have other effects.

Note that the embodiment of the present technology is not limited to that described above and may be variously changed without departing from the gist of the present technology.

Note that the present technology can also have the following configuration.

(1)

An observation apparatus including:

a first measurement unit that measures a first number of reactions of a light receiving element in response to incidence of photons on a first pixel;

a second measurement unit that measures a second number of reactions of the light receiving element in response to incidence of photons on a second pixel;

a light emitting unit that emits light to the second pixel; and

a light emission control unit that controls the light emitting unit according to a difference between the first number of reactions and the second number of reactions.

(2)

The observation apparatus according to (1), in which

the first pixel and the second pixel each use a single photon avalanche diode (SPAD) as the light receiving element.

(3)

The observation apparatus according to (1) or (2), in which

the light emitting unit is arranged in the second pixel.

(4)

The observation apparatus according to (1) or (2), in which

the light emitting unit is arranged outside the second pixel.

(5)

The observation apparatus according to any one of (1) to (4), in which

a light receiving surface side of the second pixel is shielded from light.

(6)

The observation apparatus according to any one of (1) to (5), in which

the light emission control unit controls the light emitting unit by setting a control parameter for increasing the amount of photons to be supplied to the second pixel in a case where the second number of reactions is smaller than the first number of reactions, and the light emission control unit controls the light emitting unit by setting a control parameter for decreasing the amount of photons to be supplied to the second pixel in a case where the second number of reactions is larger than the first number of reactions.

(7)

The observation apparatus according to (6), in which

the control parameter is a parameter for controlling a light emission intensity or a light emission frequency of the light emitting unit.

(8)

The observation apparatus according to any one of (1) to (7), in which

the first pixels are arranged in M×N (M≥1 and N≥1).

(9)

The observation apparatus according to (8), in which

the first measurement unit sets an average value of the number of reactions of the M×N first pixels as the first number of reactions.

(10)

The observation apparatus according to (8), in which the first measurement unit sets a maximum value or a minimum value of the number of reactions of the M×N first pixels as the first number of reactions.

(11)

The observation apparatus according to any one of (1) to (10), in which

the second pixel includes the light emitting unit provided on a side opposite to the light receiving surface side, and

a light guide portion that propagates photons is provided between the light receiving element and the light emitting unit.

(12)

The observation apparatus according to any one of (1) to (11), in which

the second pixel is a pixel for observing a characteristic of the first pixel, and

the characteristic to be observed is any one or more of photon detection efficiency (PDE), a dark count rate (DCR), a breakdown voltage Vbd, and a reaction delay time of the first pixel.

(13)

An observation method including:

by an observation apparatus,

measuring a first number of reactions of a light receiving element in response to incidence of photons on a first pixel;

measuring a second number of reactions of the light receiving element in response to incidence of photons on a second pixel; and

controlling a light emitting unit that emits light to the second pixel according to a difference between the first number of reactions and the second number of reactions.

(14)

A distance measurement system including:

a distance measurement apparatus that includes

a first light emitting unit that emits irradiation light and

a first pixel that receives reflected light obtained by reflecting the light from the first light emitting unit to an object, and measures a distance to the object; and

an observation apparatus that includes

a first measurement unit that measures a first number of reactions of a light receiving element in response to incidence of photons on the first pixel,

a second measurement unit that measures a second number of reactions of the light receiving element in response to incidence of photons on a second pixel,

a second light emitting unit that emits light to the second pixel, and

a light emission control unit that controls the second light emitting unit according to a difference between the first number of reactions and the second number of reactions, and observes a characteristic of the first pixel.

### REFERENCE SIGNS LIST

11 Distance measurement system
12 Subject
13 Subject
21 Light emitting apparatus
22 Image pickup apparatus
23 Observation apparatus
31 Light emission control unit
32 Light emitting unit
41 Image pickup unit
42 Control unit
43 Display unit
44 Storage unit
51 Lens
52 Light receiving apparatus
71 Pixel driving unit
72 Pixel array
73 Time measurement unit
74 Time measurement unit
75 Signal processing unit
76 Input/output unit
81 Pixel
82 Pixel drive line
101 Observation pixel
102 Sensor characteristic observation unit
103 Observed photon counter
104 Received photon counter
105 Photon number comparison unit
106 Light emission control unit
107 Observation pixel light emitting unit
121 Light emitting unit
132 Transistor
133 Switch
134 Inverter
135 Latch circuit
136 Inverter
137 Ground connection line
201 First substrate
202 Second substrate
211 Semiconductor substrate
212 Wiring layer
221 N-well
222 P-type diffusion layer
223 N-type diffusion layer
224 Hole accumulation layer
225 High-concentration P-type diffusion layer
257 Avalanche multiplication region
258 N-type region
259 Pixel isolation portion
281 Contact electrode
282 Contact electrode
283 Metal wiring
284 Metal wiring
285 Contact electrode
286 Contact electrode
287 Metal wiring
288 Metal wiring
311 Semiconductor substrate
312 Wiring layer
331 Metal wiring
332 Metal wiring
333 Metal wiring
334 Metal wiring
335 Contact electrode
336 Contact electrode
341 Metal wiring
361 Light guide portion
362 Light shielding member

1. An observation apparatus comprising:
a first measurement unit that measures a first number of reactions of a light receiving element in response to incidence of photons on a first pixel;
a second measurement unit that measures a second number of reactions of the light receiving element in response to incidence of photons on a second pixel;
a light emitting unit that emits light to the second pixel; and
a light emission control unit that controls the light emitting unit according to a difference between the first number of reactions and the second number of reactions.

2. The observation apparatus according to claim 1, wherein
the first pixel and the second pixel each use a single photon avalanche diode (SPAD) as the light receiving element.

3. The observation apparatus according to claim 1, wherein
the light emitting unit is arranged in the second pixel.

4. The observation apparatus according to claim 1, wherein
the light emitting unit is arranged outside the second pixel.

5. The observation apparatus according to claim 1, wherein
a light receiving surface side of the second pixel is shielded from light.

6. The observation apparatus according to claim 1, wherein
the light emission control unit controls the light emitting unit by setting a control parameter for increasing an amount of photons to be supplied to the second pixel in a case where the second number of reactions is smaller than the first number of reactions, and the light emission control unit controls the light emitting unit by setting a control parameter for decreasing the amount of photons to be supplied to the second pixel in a case where the second number of reactions is larger than the first number of reactions.

7. The observation apparatus according to claim 6, wherein
the control parameter is a parameter for controlling a light emission intensity or a light emission frequency of the light emitting unit.

8. The observation apparatus according to claim 1, wherein
the first pixels are arranged in M×N (M≥1 and N≥1).

9. The observation apparatus according to claim 8, wherein
the first measurement unit sets an average value of the number of reactions of the M×N first pixels as the first number of reactions.

10. The observation apparatus according to claim 8, wherein
the first measurement unit sets a maximum value or a minimum value of the number of reactions of the M×N first pixels as the first number of reactions.

11. The observation apparatus according to claim 1, wherein
the second pixel includes the light emitting unit provided on a side opposite to the light receiving surface side, and
a light guide portion that propagates photons is provided between the light receiving element and the light emitting unit.

12. The observation apparatus according to claim 1, wherein
the second pixel is a pixel for observing a characteristic of the first pixel, and
the characteristic to be observed is any one or more of photon detection efficiency (PDE), a dark count rate (DCR), a breakdown voltage Vbd, and a reaction delay time of the first pixel.

13. An observation method comprising:
by an observation apparatus,
measuring a first number of reactions of a light receiving element in response to incidence of photons on a first pixel;
measuring a second number of reactions of the light receiving element in response to incidence of photons on a second pixel; and
controlling a light emitting unit that emits light to the second pixel according to a difference between the first number of reactions and the second number of reactions.

14. A distance measurement system comprising:
a distance measurement apparatus that includes
a first light emitting unit that emits irradiation light and
a first pixel that receives reflected light obtained by reflecting the light from the first light emitting unit to an object, and measures a distance to the object; and
an observation apparatus that includes
a first measurement unit that measures a first number of reactions of a light receiving element in response to incidence of photons on the first pixel,
a second measurement unit that measures a second number of reactions of the light receiving element in response to incidence of photons on a second pixel,
a second light emitting unit that emits light to the second pixel, and
a light emission control unit that controls the second light emitting unit according to a difference between the first number of reactions and the second number of reactions, and observes a characteristic of the first pixel.
